(19) United States
(12) Patent Application Publication
(10) Pub. No.: US 2022/0161435 A1
(43) Pub. Date: May 26, 2022

(54) CONTROL DEVICE, CONTROL METHOD, AND COMPUTER-READABLE MEDIUM

(71) Applicant: Mitsubishi Electric Corporation, Tokyo (JP)

(72) Inventors: Takayuki TSUKITANI, Tokyo (JP); Yusuke YOKOSUKA, Tokyo (JP); Masato HIRAI, Tokyo (JP); Hirofumi FUKAGAWA, Tokyo (JP)

(73) Assignee: Mitsubishi Electric Corporation, Tokyo (JP)

(21) Appl. No.: 17/669,397

(22) Filed: Feb. 11, 2022

Related U.S. Application Data
(63) Continuation of application No. PCT/JP2019/036591, filed on Sep. 18, 2019.

(51) Int. Cl. B25J 9/16; B25J 13/08; B25J 7/00

(52) U.S. Cl. CPC B25J 9/1682; B25J 7/00; B25J 13/085; B25J 9/1689

(57) ABSTRACT

In a mobile interaction robot, a plurality of self-propelled robots is connected to each other by a long object.

### CROSS-REFERENCE TO RELATED APPLICATION

The present application is a continuation of International Patent Application PCT/JP2019/036591, filed Sep. 18, 2019, the entire contents of which are incorporated herein by reference.

### TECHNICAL FIELD

The present invention relates to a control device, a control method, and a computer-readable medium.

### BACKGROUND ART

Human computer interaction (hereinafter, referred to as “HCI”) using a robot has been studied. For example, Non-Patent Literature 1 discloses HCI in which a plurality of microrobots is used, and the microrobots are moved on the basis of an operation performed on the microrobots by a user, or the microrobots are moved so as to prompt a user to take an action on the basis of a situation around the microrobots. In addition, Non-Patent Literature 2 discloses a microrobot and a control system of the microrobot for implementing the HCI disclosed in Non-Patent Literature 1.

### CITATION LIST

### Non-Patent Literature

Non-Patent Literature 1: “Lawrence H. Kim, Sean Follmer”, “UbiSwarm: Ubiquitous Robotic Interfaces and Investigation of Abstract Motion as a Display”, [online], 2017, “Stanford University Department of Mechanical Engineering”, [searched on Apr. 19, 2019], Internet <URL: http://shape.stanford.edu/research/UbiSwarm/>
Non-Patent Literature 2: “Mathieu Le Goc, Lawrence H. Kim, Ali Parsaei, Jean-Daniel Feketel, Pierre Dragicevic, Sean Follmer”, “Zooids: Building Block for Swarm User Interface”, [online], 2016, “Stanford University Department of Mechanical Engineering”, [searched on Apr. 19, 2019], Internet <URL:
http://shape.stanford.edu/research/swarm/>

### SUMMARY OF INVENTION

### Technical Problem

However, for example, in the HCI using the microrobot disclosed in Non-Patent Literature 2, since a plurality of the microrobots is independent of each other, an operation method for a user to control the robots, an expression method for the robots to prompt the user to take an action, or the like is limited. Therefore, it is difficult for the microrobot disclosed in Non-Patent Literature 2 to provide a wide variety of HCI.

The present invention is intended to solve the above-described problem, and an object thereof is to provide a robot capable of providing a wide variety of HCI.

### Solution to Problem

A control device comprising processing circuitry to acquire mobile interaction robot information indicating a state of a mobile interaction robot including a plurality of self-propelled robots and a long object, the plurality of self-propelled robots being connected to each other by the long object, and to generate control information for controlling a control target on a basis of the mobile interaction robot information.

### Advantageous Effects of Invention

According to the present invention, a wide variety of HCI can be provided.

### BRIEF DESCRIPTION OF DRAWINGS

FIG. 1 is a configuration diagram illustrating an example of a configuration of a main part of a robot system to which a mobile interaction robot and a control device according to a first embodiment are applied.

FIG. 2 is a configuration diagram illustrating an example of a configuration of a main part of the mobile interaction robot according to the first embodiment.

FIG. 3 is a block diagram illustrating an example of a configuration of a main part of a robot included in the mobile interaction robot according to the first embodiment.

FIG. 4 is a block diagram illustrating an example of a configuration of a main part of the control device according to the first embodiment.

FIGS. 5A and 5B are diagrams illustrating an example of a hardware configuration of a main part of the control device according to the first embodiment.

FIG. 6 is a flowchart for explaining an example of processing of the control device according to the first embodiment.

FIG. 7 is a flowchart for explaining an example of processing of the control device according to the first embodiment.

FIG. 8 is a diagram illustrating a connection example of a mobile interaction robot in which three or more self-propelled robots are connected to each other by a long object.

FIG. 9 is a configuration diagram illustrating an example of a configuration of a main part of a robot system to which a mobile interaction robot and a control device according to a second embodiment are applied.

FIG. 10 is a configuration diagram illustrating an example of a configuration of a main part of the mobile interaction robot according to the second embodiment.

FIG. 11 is a block diagram illustrating an example of a configuration of a main part of the control device according to the second embodiment.

FIG. 12 is a flowchart for explaining an example of processing of the control device according to the second embodiment.

FIG. 13 is a configuration diagram illustrating an example of a configuration of a main part of a robot system to which a mobile interaction robot and a control device according to a third embodiment are applied.

FIG. 14 is a configuration diagram illustrating an example of a configuration of a main part of the mobile interaction robot according to the third embodiment.

FIG. 15 is a block diagram illustrating an example of a configuration of a main part of the control device according to the third embodiment.

FIG. 16 is a flowchart for explaining an example of processing of the control device according to the third embodiment.

FIG. 17 is a configuration diagram illustrating an example of a configuration of a main part of a robot system to which a mobile interaction robot and a control device according to a fourth embodiment are applied.

FIG. 18 is a configuration diagram illustrating an example of a configuration of a main part of the mobile interaction robot according to the fourth embodiment.

FIG. 19 is a block diagram illustrating an example of a configuration of a main part of the control device according to the fourth embodiment.

FIG. 20 is a flowchart for explaining an example of processing of the control device according to the fourth embodiment.

### DESCRIPTION OF EMBODIMENTS

Hereinafter, some embodiments of the present invention will be described in detail with reference to the drawings.

### First Embodiment

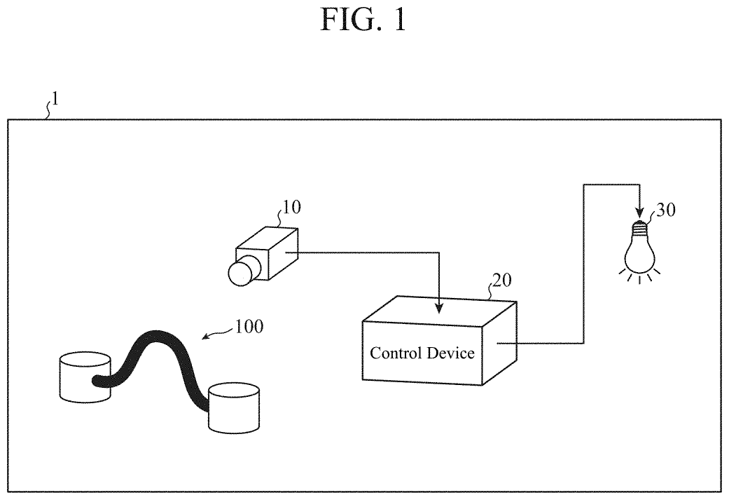

A mobile interaction robot 100 and a control device 20 according to a first embodiment will be described with reference to FIGS. 1 to 8.

FIG. 1 is a configuration diagram illustrating an example of a configuration of a main part of a robot system 1 to which the mobile interaction robot 100 and the control device 20 according to the first embodiment are applied.

The robot system 1 includes the mobile interaction robot 100, an imaging device 10, the control device 20, and an external device 30.

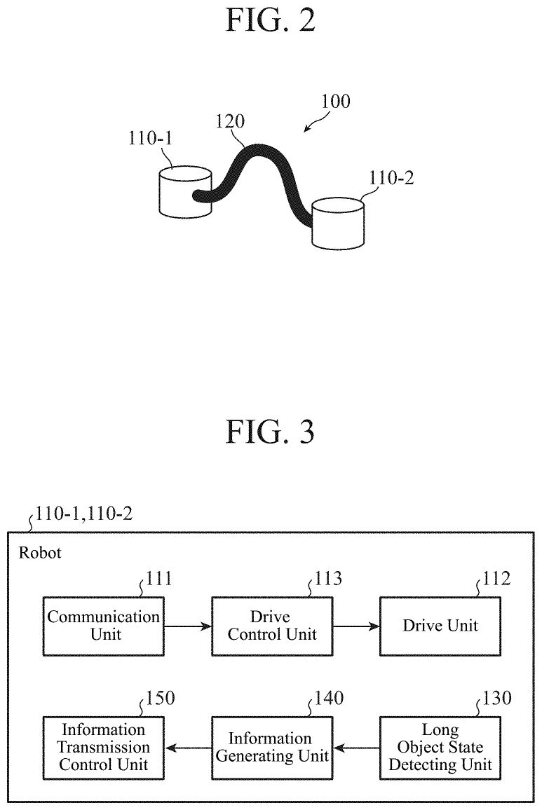

FIG. 2 is a configuration diagram illustrating an example of a configuration of a main part of the mobile interaction robot 100 according to the first embodiment.

The mobile interaction robot 100 includes robots 110-1 and 110-2, a long object 120, a long object state detecting unit 130, an information generating unit 140, and an information transmission controlling unit ISO.

A configuration of a main part of each of the robots 110-1 and 110-2 will be described with reference to FIG. 3.

FIG. 3 is a block diagram illustrating an example of a configuration of a main part of each of the robots 110-1 and 110-2 included in the mobile interaction robot 100 according to the first embodiment.

Each of the robot 110-1 and the robot 110-2 includes the configuration illustrated in FIG. 3 as a main part.

Each of the robot 110-1 and the robot 110-2 includes a communication unit 111, a drive unit 112, and a drive control unit 113.

Each of the robots 110-1 and the robot 110-2 is self-propelled.

The communication unit 111 receives control information, which is information for moving the robots 110-1 and 110-2, from the control device 20. The control information is, for example, information indicating a traveling start, a traveling stop, or a traveling direction. The control information may be information indicating the positions of the robots 110-1 and 110-2 after movement. The communication unit Ill receives the control information from the control device 20 by a wireless communication means such as infrared communication, Bluetooth (registered trademark), or Wi-Fi (registered trademark).

The drive unit 112 is hardware for causing the robots 110-1 and 110-2 to travel. The drive unit 112 is, for example, hardware such as a wheel, a motor for driving the wheel, a brake for stopping the wheel, or a direction changing mechanism for changing a direction of the wheel.

The drive control unit 113 causes the robots 110-1 and 110-2 to travel by controlling the drive unit 112 on the basis of the control information received by the communication unit 111.

That is, by including the communication unit 111, the drive unit 112, and the drive control unit 113, the robots 110-1 and 110-2 move by self-propelling on the basis of the received control information.

Each of the robots 110-1 and 110-2 according to the first embodiment is, for example, the microrobot disclosed in Non-Patent Literature 2. Each of the robots 110-1 and 110-2 is not limited to the microrobot disclosed in Non-Patent Literature 2. In addition, each of the robots 110-1 and 110-2 may be larger or smaller than the microrobot disclosed in Non-Patent Literature 2.

Note that each of the robots 110-1 and 110-2 includes a power supply means (not illustrated) such as a battery, and the communication unit 111, the drive unit 112, and the drive control unit 113 each operate by receiving power supply from the power supply means.

In addition, each of the robots 110-1 and 110-2 includes, for example, at least one of a processor and a memory, or a processing circuit. Functions of the communication unit 111 and the drive control unit 113 are implemented by, for example, at least one of a processor and a memory, or a processing circuit.

The processor is implemented by, for example, a central processing unit (CPU), a graphics processing unit (GPU), a microprocessor, a microcontroller, or a digital signal processor (DSP).

The memory is implemented by, for example, a semiconductor memory or a magnetic disk. More specifically, the memory is implemented by, for example, a random access memory (RAM), a read only memory (ROM), a flash memory, an erasable programmable read only memory (EPROM), an electrically erasable programmable read-only memory (EEPROM), a solid state drive (SSD), or a hard disk drive (HDD).

The processing circuit is implemented by, for example, an application specific integrated circuit (ASIC), a programmable logic device (PLD), a field-programmable gate array (FPGA), a system-on-a-chip (SoC), or a system large-scale integration (LSI).

The long object 120 is a long object made of an elastic material, a plastic material, a cable member, or the like. One end of the long object 120 is connected to the robot 110-1, and the other end of the long object 120 is connected to the robot 110-2.

That is, the mobile interaction robot 100 is obtained by connecting the self-propelled robot 110-1 and the self-propelled robot 110-2 to each other by the long object 120.

The long object 120 according to the first embodiment will be described below as being made of a plastic material such as resin or metal.

The long object state detecting unit 130 is a detection means to detect contact between an object, the object being other than the long object 120 or the robots 110-1 and 110-2 connected to the long object, and the long object 120 (hereinafter, referred to as “contact detecting means”). The long object state detecting unit 130 transmits a detection signal indicating the detected state of the long object 120 to the information generating unit 140.

The contact detecting means is constituted by, for example, a touch sensor for detecting contact of a user's finger or the like. More specifically, the long object state detecting unit 130 is constituted by disposing a touch sensor on a surface of the long object 120 made of a plastic material and connecting the touch sensor to the information generating unit 140 by a conductive wire.

As for the long object state detecting unit 130, at least apart of hardware constituting the long object state detecting unit 130 may be included in the long object 120, and a part of the remainder may be included in the robot 110-1 or the robot 110-2. Specifically, for example, as for the long object state detecting unit 130, among pieces of hardware constituting the long object state detecting unit 130, a piece of hardware that comes into contact with a user's finger or the like may be included in the long object 120, and a touch sensor that is hardware for generating a detection signal may be included in the robot 110-1 or the robot 110-2. More specifically, for example, the long object state detecting unit 130 may be constituted by making the long object 120 of a conductive material such as a metal wire or a metal rod, and connecting the long object 120 made of the conductive material to a touch sensor included in the robot 110-1 or the robot 110-2.

The information generating unit 140 receives a detection signal from the long object state detecting unit 130, and generates mobile interaction robot information indicating a state of the long object 120 on the basis of the received detection signal.

The information generating unit 140 is included in the robot 110-1, the robot 110-2, or the long object 120.

When the information generating unit 140 includes a detection means to detect the position, moving speed, moving direction, or the like of the robot 110-1, the robot 110-2, or the long object 120 by a navigation system or the like, the mobile interaction robot information generated by the information generating unit 140 may include information indicating the position, moving speed, moving direction, or the like of the robot 110-1, the robot 110-2, or the long object 120 in addition to information indicating a state of the long object 120.

The detection means to detect the position, moving speed, moving direction, or the like of the robot 110-1, the robot 110-2, or the long object 120 is not limited to the navigation system.

For example, pieces of traveling surface position information such as markers or the like indicating the positions on a traveling surface on which the robot 110-1 and the robot 110-2 travel are arranged in a grid pattern. In addition, a position information reading unit (not illustrated) for acquiring traveling surface position information by reading traveling surface position information of the marker or the like is included at a position facing the traveling surface in the robot 110-1 or the robot 110-2. The information generating unit 140 generates information indicating the moving speed, moving direction, or the like of the robot 110-1, the robot 110-2, or the long object 120 on the basis of the traveling surface position information acquired by the position information reading unit while the robot 110-1 or the robot 110-2 is traveling. The information generating unit 140 may generate the mobile interaction robot information by including the generated information indicating the moving speed, moving direction, or the like of the robot 110-1, the robot 110-2, or the long object 120 in the mobile interaction robot information.

The information transmission controlling unit 150 transmits the mobile interaction robot information generated by the information generating unit 140 to the control device 20. The information transmission controlling unit 150 transmits the mobile interaction robot information to the control device 20 by a wireless communication means such as infrared communication, Bluetooth (registered trademark), or Wi-Fi (registered trademark).

The information transmission controlling unit 150 is included in the robot 110-1, the robot 110-2, or the long object 120. When the information transmission controlling unit 150 is included in the robot 110-1 or the robot 110-2, the communication unit 111 included in each of the robots 110-1 and 110-2 may have the function of the information transmission controlling unit 150.

Note that the long object state detecting unit 130, the information generating unit 140, and the information transmission controlling unit 150 operate by receiving power supply from a power supply means (not illustrated) such as a battery included in the long object 120, a power supply means (not illustrated) such as a battery included in the robot 110-1 or the robot 110-2, or the like.

In addition, the functions of the information generating unit 140 and the information transmission controlling unit 150 in the mobile interaction robot 100 are implemented by at least one of a processor and a memory, or a processing circuit. The processor and the memory or the processing circuit for implementing the functions of the information generating unit 140 and the information transmission controlling unit 150 in the mobile interaction robot 100 is included in the long object 120, the robot 110-1, or the robot 110-2. Since the processor, the memory, and the processing circuit have been described above, description thereof will be omitted.

In addition, in the mobile interaction robot 100, the information generating unit 140 is not an essential component, and the mobile interaction robot 100 does not have to include the information generating unit 140. When the mobile interaction robot 100 does not include the information generating unit 140, for example, the information transmission controlling unit 150 receives a detection signal from the long object state detecting unit 130, and the information transmission controlling unit 150 transmits the received detection signal to the control device 20 using the detection signal as mobile interaction robot information.

The imaging device 10 is, for example, a camera such as a digital still camera or a digital video camera. The imaging device 10 captures an image of the mobile interaction robot 100, and transmits the captured image as image information to the control device 20 via a communication means. The imaging device 10 and the control device 20 are connected to each other by a communication means such as a wired communication means like a universal serial bus (USB), a network cable in a local area network (LAN), or the Institute of Electrical and Electronics Engineers (IEEE) 1394, or a wireless communication means like Wi-Fi. The imaging device 10 may capture an image of the external device 30, a user who operates the mobile interaction robot 100, or the like in addition to an image of the mobile interaction robot 100.

The control device 20 acquires mobile interaction robot information indicating a state of the mobile interaction robot 100, and controls a control target on the basis of the acquired mobile interaction robot information.

The control target controlled by the control device 20 is the mobile interaction robot 100, or the mobile interaction robot 100 and the external device 30.

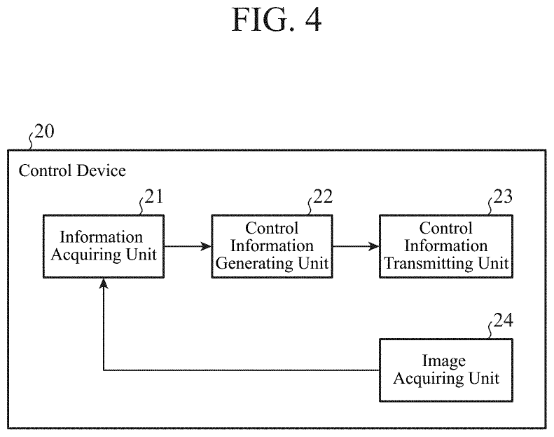

A configuration of a main part of the control device 20 according to the first embodiment will be described with reference to FIG. 4.

FIG. 4 is a block diagram illustrating an example of a configuration of a main part of the control device 20 according to the first embodiment.

The control device 20 includes an information acquiring unit 21, a control information generating unit 22, a control information transmitting unit 23, and an image acquiring unit 24.

The image acquiring unit 24 acquires image information transmitted by the imaging device 10.

The information acquiring unit 21 acquires mobile interaction robot information indicating a state of the mobile interaction robot 100.

Specifically, the information acquiring unit 21 acquires mobile interaction robot information by receiving mobile interaction robot information transmitted by the mobile interaction robot 100.

More specifically, the information acquiring unit 21 acquires mobile interaction robot information indicating a state of the mobile interaction robot 100, such as the position, moving speed, moving direction, or the like of the robot 110-4 included in the mobile interaction robot 100, the position, moving speed, moving direction, or the like of the robot 110-2 included in the mobile interaction robot 100, or the position, moving speed, moving direction, state, or the like of the long object 120 included in the mobile interaction robot 100.

In addition, the information acquiring unit 21 may include an image analysis means, and may acquire mobile interaction robot information by analyzing image information acquired by the image acquiring unit 24 from the imaging device 10.

More specifically, by analyzing the image information acquired by the image acquiring unit 24 from the imaging device 10, the information acquiring unit 21 acquires mobile interaction robot information indicating a state of the mobile interaction robot 100, such as the position, moving speed, moving direction, or the like of the robot 110-1 included in the mobile interaction robot 100, the position, moving speed, moving direction, or the like of the robot 110-2 included in the mobile interaction robot 100, or the position, moving speed, moving direction, state, or the like of the long object 120 included in the mobile interaction robot 100.

A technique of analyzing the position, moving speed, moving direction, situation, or the like of an object appearing in an image indicated by image information by analyzing the image information is a well-known technique, and therefore description thereof will be omitted.

When the imaging device 10 captures an image of the external device 30, a user, or the like in addition to an image of the mobile interaction robot 100, by analyzing the image information acquired by the image acquiring unit 24 from the imaging device 10, the information acquiring unit 21 may acquire information indicating a relative position of the mobile interaction robot 100, or the robot 110-1, the robot 110-2, or the long object 120 included in the mobile interaction robot 100 with respect to the external device 30, the user, or the like as mobile interaction robot information.

Note that, when it is not configured in such a manner that the information acquiring unit 21 acquires mobile interaction robot information indicating a state of the mobile interaction robot 100, such as the position, moving speed, moving direction, or the like of the robot 110-1 included in the mobile interaction robot 100, the position, moving speed, moving direction, or the like of the robot 110-2 included in the mobile interaction robot 100, or the position, moving speed, moving direction, state, or the like of the long object 120 included in the mobile interaction robot 100, and by analyzing the image information acquired by the image acquiring unit 24 from the imaging device 10, the information acquiring unit 21 acquires information indicating a relative position of the mobile interaction robot 100, or the robot 110-1, the robot 110-2, or the long object 120 included in the mobile interaction robot 100 with respect to the external device 30, the user, or the like as mobile interaction robot information, the imaging device 10 and the image acquiring unit 24 are not essential components.

The control information generating unit 22 generates control information for controlling a control target on the basis of the mobile interaction robot information acquired by the information acquiring unit 21.

For example, the control information generating unit 22 generates control information for controlling the mobile interaction robot 100 on the basis of the mobile interaction robot information acquired by the information acquiring unit 21.

Specifically, the control information generating unit 22 generates control information for controlling travel of the robot 110-1 and the robot 110-2 included in the mobile interaction robot 100 on the basis of the mobile interaction robot information acquired by the information acquiring unit 21.

More specifically, the control information generating unit 22 generates control information for controlling travel of the robot 110-1 and the robot 110-2 on the basis of the position, moving speed, moving direction, or the like of the robot 110-1, the position, moving speed, moving direction, or the like of the robot 110-2, or the position, moving speed, moving direction, state, or the like of the long object 120, indicated by the mobile interaction robot information.

Further, for example, the control information generating unit 22 may generate control information for controlling the external device 30 on the basis of the mobile interaction robot information in addition to the control information for controlling the mobile interaction robot 100.

The control information transmitting unit 23 transmits the control information generated by the control information generating unit 22 to the mobile interaction robot 100 or the external device 30 as a control target.

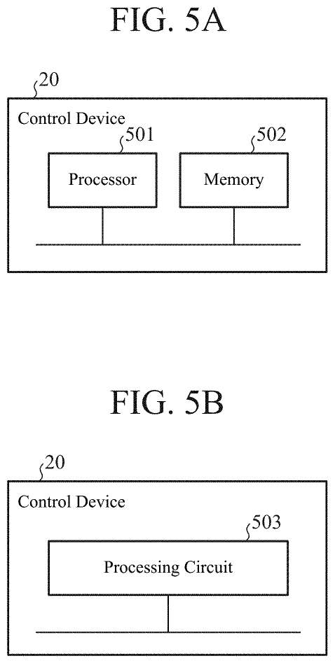

A hardware configuration of a main part of the control device 20 according to the first embodiment will be described with reference to FIGS. 5A and 5B.

FIGS. 5A and 5B are diagrams illustrating an example of a hardware configuration of a main part of the control device 20 according to the first embodiment.

As illustrated in FIG. 5A, the control device 20 is constituted by a computer, and the computer includes a processor 501 and a memory 502. The memory 502 stores a program for causing the computer to function as the information acquiring unit 21, the control information generating unit 22, the control information transmitting unit 23, and the image acquiring unit 24. When the processor 501 reads and executes the program stored in the memory 502, the information acquiring unit 21, the control information generating unit 22, the control information transmitting unit 23, and the image acquiring unit 24 are implemented.

In addition, as illustrated in FIG. 5B, the mobile interaction robot 100 may be constituted by a processing circuit 503. In this case, the functions of the information acquiring unit 21, the control information generating unit 22, the control information transmitting unit 23, and the image acquiring unit 24 may be implemented by the processing circuit 503.

In addition, the mobile interaction robot 100 may be constituted by the processor 501, the memory 502, and the processing circuit 503 (not illustrated). In this case, some of the functions of the information acquiring unit 21, the control information generating unit 22, the control information transmitting unit 23, and the image acquiring unit 24 may be implemented by the processor 501 and the memory 502, and the remaining functions may be implemented by the processing circuit 503.

Since the processor 501, the memory 502, and the processing circuit 503 are similar to the processor, the memory, and the processing circuit included in the mobile interaction robot 100 or the robots 110-1 and 110-2 described above, description thereof will be omitted.

The external device 30 is, for example, an illumination device. The illumination device is merely an example, and the external device 30 is not limited to the illumination device. FIG. 1 illustrates an example in which an illumination device is used as the external device 30. Hereinafter, the external device 30 according to the first embodiment will be described as an illumination device.

HCI according to the first embodiment will be described.

In first HCI according to the first embodiment, the external device 30 is controlled by a user's touch on the long object 120 of the mobile interaction robot 100. Specifically, for example, in the first HCI, the illumination device which is the external device 30 is controlled so as to be turned on or off by a user's touch on the long object 120 of the mobile interaction robot 100.

When a user touches the long object 120 of the mobile interaction robot 100, the long object state detecting unit 130 of the mobile interaction robot 100 detects that the user touches the long object 120. The information generating unit 140 in the mobile interaction robot 1X) generates mobile interaction robot information indicating that the long object 120 is touched as mobile interaction robot information indicating a state of the long object 120. The information transmission controlling unit 150 in the mobile interaction robot 100 transmits the mobile interaction robot information generated by the information generating unit 140 to the control device 20.

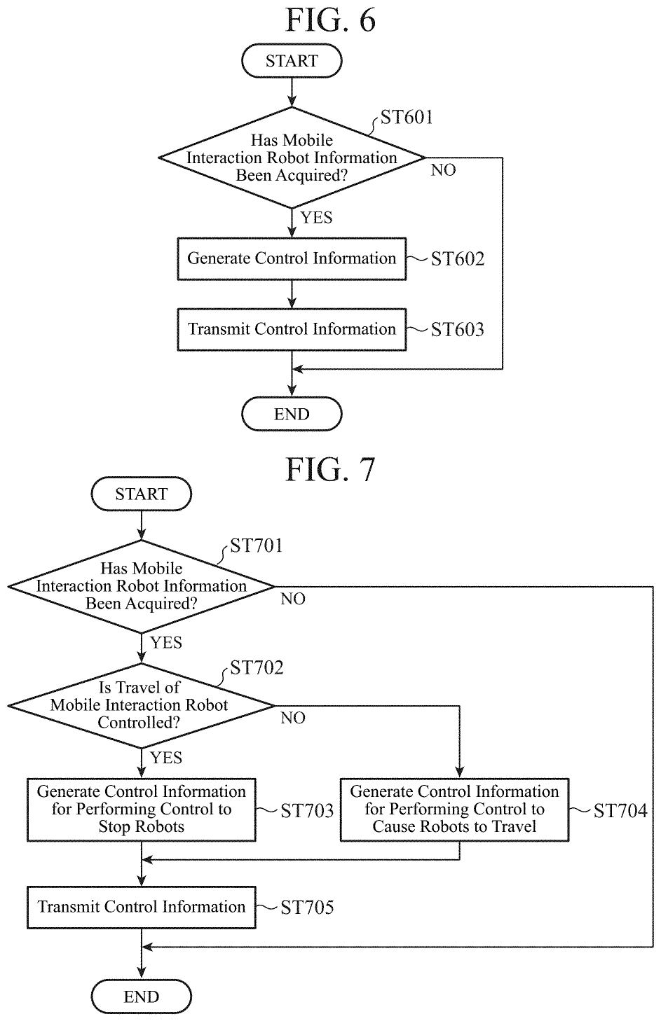

FIG. 6 is a flowchart for explaining an example of processing of the control device 20 according to the first embodiment. The control device 20 repeatedly executes the processing of the flowchart.

First, in step ST601, the information acquiring unit 21 determines whether or not mobile interaction robot information has been acquired from the mobile interaction robot 100.

In step ST601, if the information acquiring unit 21 determines that mobile interaction robot information has not been acquired from the mobile interaction robot 100, the control device 20 ends the processing of the flowchart, returns to step ST601, and repeatedly executes the processing of the flowchart.

In step ST601, if the information acquiring unit 21 determines that mobile interaction robot information has been acquired from the mobile interaction robot 100, in step ST602, the control information generating unit 22 generates control information for controlling the illumination device which is the external device 30 on the basis of the mobile interaction robot information.

After step ST602, in step ST603, the control information transmitting unit 23 transmits the control information generated by the control information generating unit 22 to the external device 30.

After step ST603, the control device 20 ends the processing of the flowchart, returns to step ST601, and repeatedly executes the processing of the flowchart.

The external device 30 acquires the control information transmitted by the control device 20 and operates on the basis of the acquired control information.

Specifically, for example, the illumination device which is the external device 30 is turned on or off on the basis of the control information.

In second HCI according to the first embodiment, the mobile interaction robot 100 is controlled by a user's touch on the long object 120 of the mobile interaction robot 100. Specifically, for example, in the second HCI, travel of the robot 110-1 and the robot 110-2 included in the mobile interaction robot 100 is controlled by a user's touch on the long object 120 of the mobile interaction robot 100.

When a user touches the long object 120 of the mobile interaction robot 100, the long object state detecting unit 130 of the mobile interaction robot 100 detects that the user touches the long object 120. The information generating unit 140 in the mobile interaction robot 100 generates mobile interaction robot information indicating that the long object 120 is touched as mobile interaction robot information indicating a state of the long object 120. The information transmission controlling unit 150 in the mobile interaction robot 100 transmits the mobile interaction robot information generated by the information generating unit 140 to the control device 20.

FIG. 7 is a flowchart for explaining an example of processing of the control device 20 according to the first embodiment. The control device 20 repeatedly executes the processing of the flowchart.

First, in step ST701, the information acquiring unit 21 determines whether or not mobile interaction robot information has been acquired from the mobile interaction robot 100.

In step ST701, if the information acquiring unit 21 determines that mobile interaction robot information has not been acquired from the mobile interaction robot 100, the control device 20 ends the processing of the flowchart, returns to step ST701, and repeatedly executes the processing of the flowchart.

In step ST701, if the information acquiring unit 21 determines that mobile interaction robot information has been acquired from the mobile interaction robot 100, in step ST702, the control information generating unit 22 determines whether or not travel of the mobile interaction robot 100 is controlled.

In step ST702, if the control information generating unit 22 determines that travel of the robot 110-1 and the robot 110-2 included in the mobile interaction robot 100 is controlled, in step ST703, the control information generating unit 22 generates control information for performing control to stop the robot 110-1 and the robot 110-2 included in the mobile interaction robot 100 on the basis of the mobile interaction robot information.

In step ST702, if the control information generating unit 22 determines that travel of the robot 110-1 and the robot 110-2 included in the mobile interaction robot 100 is not controlled, in step ST704, the control information generating unit 22 generates control information for performing control to cause the robot 110-1 and the robot 110-2 included in the mobile interaction robot 100 to travel toward a predetermined position or the like on the basis of the mobile interaction robot information.

After step ST703 or step ST704, in step ST705, the control information transmitting unit 23 transmits the control information generated by the control information generating unit 22 to the robot 110-1 and the robot 110-2 included in the mobile interaction robot 100.

After step ST705, the control device 20 ends the processing of the flowchart, returns to step ST701, and repeatedly executes the processing of the flowchart.

The robot 110-1 and the robot 110-2 included in the mobile interaction robot 100 acquire the control information transmitted by the control device 20 and operate on the basis of the acquired control information. Specifically, for example, the robot 110-1 and the robot 110-2 included in the mobile interaction robot 100 start or stop traveling on the basis of the control information.

Note that the mobile interaction robot 100 described above has been described as a mobile interaction robot including the two self-propelled robots 110-1 and 110-2, in which the two self-propelled robots 110-1 and 110-2 are connected to each other by the long object 120. However, the number of robots 110-1 and 110-2 included in the mobile interaction robot 100 is not limited to two. The mobile interaction robot 100 may be a mobile interaction robot including three or more self-propelled robots, in which the three or more self-propelled robots are connected to each other by the long object 120.

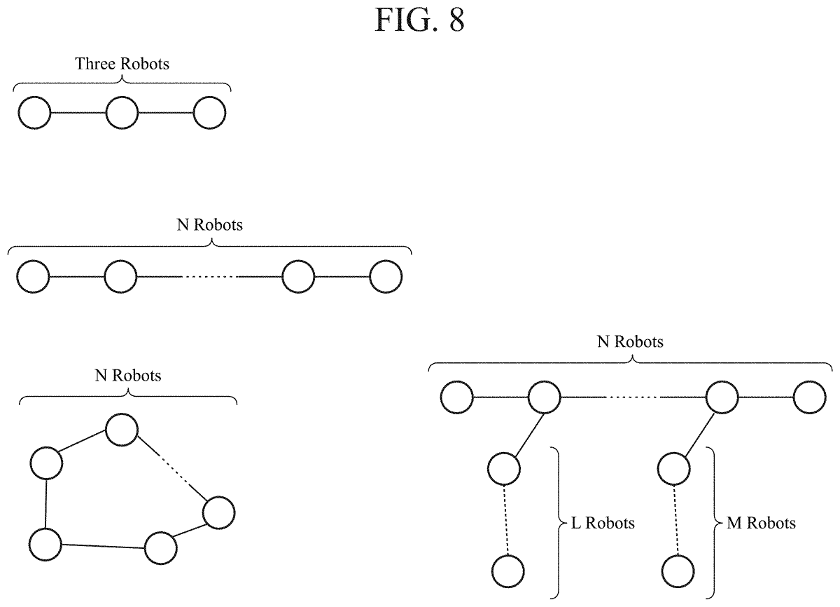

FIG. 8 is a diagram illustrating a connection example of the mobile interaction robot 100 in which three or more self-propelled robots are connected to each other by the long object 120.

FIG. 8 illustrates a self-propelled robot included in a mobile interaction robot by a circle, and illustrates a long object connecting the robots to each other by a line segment between the circle. In addition, N illustrated in FIG. 8 indicates an arbitrary natural number equal to or larger than two indicating the number of robots, and L and M each indicate an arbitrary natural number equal to or larger than one indicating the number of robots.

Note that FIG. 8 is an example, and the connection between the plurality of self-propelled robots and the long object included in the mobile interaction robot is not limited to the connection example illustrated in FIG. 8.

As described above, in the mobile interaction robot 100, a plurality of self-propelled robots is connected to each other by the long object 120.

With this configuration, the mobile interaction robot 100 can provide a wide variety of HCI.

In addition, in the above-described configuration, the long object 120 included in the mobile interaction robot 100 is made of a plastic material.

With this configuration, the mobile interaction robot 100 can provide a wide variety of HCI.

In addition, the mobile interaction robot 100 includes the long object state detecting unit 130 for detecting a state of the long object 120 in addition to the above-described configuration.

With this configuration, the mobile interaction robot 100 can provide a wide variety of HCI.

In addition, in the above-described configuration, the long object state detecting unit 130 included in the mobile interaction robot 100 detects contact between the long object 120 and an object other than the long object 120 or the robots connected to the long object 120.

With this configuration, the mobile interaction robot 100 can provide a wide variety of HCI.

In addition, the control device 20 includes the information acquiring unit 21 for acquiring mobile interaction robot information indicating a state of the mobile interaction robot 100, and the control information generating unit 22 for generating control information for controlling a control target on the basis of the mobile interaction robot information acquired by the information acquiring unit 21.

With this configuration, the control device 20 can provide a wide variety of HCI.

In addition, with this configuration, the control device 20 can cause the mobile interaction robot 100 or the external device 30 as a control target to perform a desired operation depending on a state of the mobile interaction robot 100.

In addition, in the above-described configuration, the mobile interaction robot information acquired by the information acquiring unit 21 included in the control device 20 includes information indicating the position of the mobile interaction robot 100.

With this configuration, the control device 20 can provide a wide variety of HCI.

In addition, with this configuration, the control device 20 can accurately control travel of the plurality of robots 110-1 and 110-2 included in the mobile interaction robot 100 as a control target depending on the position of the mobile interaction robot 100, and can accurately move the mobile interaction robot 100.

In addition, in the above-described configuration, the information indicating a position included in the mobile interaction robot information acquired by the information acquiring unit 21 included in the control device 20 includes information indicating the position of each of the plurality of robots 110-1 and 110-2 included in the mobile interaction robot 100.

With this configuration, the control device 20 can provide a wide variety of HCI.

In addition, with this configuration, the control device 20 can accurately control travel of the plurality of robots 110-1 and 110-2 included in the mobile interaction robot 100 as a control target depending on the positions of the plurality of robots 110-1 and 110-2 included in the mobile interaction robot 100, and can accurately move the mobile interaction robot 100.

In addition, in the above-described configuration, the information indicating a position included in the mobile interaction robot information acquired by the information acquiring unit 21 included in the control device 20 includes information indicating the position of the long object 120 included in the mobile interaction robot 100.

With this configuration, the control device 20 can provide a wide variety of HCI.

In addition, with this configuration, the control device 20 can accurately control travel of the plurality of robots 110-1 and 110-2 included in the mobile interaction robot 100 as a control target depending on the position of the long object 120 included in the mobile interaction robot 100, and can accurately move the mobile interaction robot 100.

In addition, in the above-described configuration, the mobile interaction robot information acquired by the information acquiring unit 21 included in the control device 20 includes information indicating contact between the long object 120 included in the mobile interaction robot 100 and an object other than the long object 120 or the robots included in the mobile interaction robot 100.

With this configuration, the control device 20 can provide a wide variety of HCI.

In addition, with this configuration, the control device 20 can cause the external device 30 as a control target to perform a desired operation depending on whether or not the long object 120 included in the mobile interaction robot 100 has come into contact with an object other than the long object 120 or the robots.

In addition, in the above-described configuration, the control information generated by the control information generating unit 22 included in the control device 20 is control information for controlling the mobile interaction robot 100 as a control target, and the control information generating unit 22 generates control information for controlling travel of the plurality of robots 110-1 and 110-2 included in the mobile interaction robot 100 on the basis of the mobile interaction robot information acquired by the information acquiring unit 21.

With this configuration, the control device 20 can provide a wide variety of HCI.

In addition, with this configuration, the control device 20 can control travel of the robots 110-1 and 110-2 included in the mobile interaction robot 100 as a control target depending on a state of the mobile interaction robot 100, and can move the mobile interaction robot 100.

In addition, in the above-described configuration, the control information generated by the control information generating unit 22 included in the control device 20 is control information for controlling the external device 30, and the control information generating unit 22 generates the control information for controlling the external device 30 on the basis of the mobile interaction robot information acquired by the information acquiring unit 21.

With this configuration, the control device 20 can provide a wide variety of HCI.

In addition, with this configuration, the control device 20 can cause the external device 30 as a control target to perform a desired operation depending on a state of the mobile interaction robot 100.

Note that, in the first embodiment, the external device 30 has been described as, for example, an illumination device, but as described above, the external device 30 is not limited to the illumination device. The external device 30 may be an electronic device such as an information device, a display control device, or an acoustic device, or a device such as a machine driven by electronic control.

In addition, in the first embodiment, the control information controlled by the control information generating unit 22 has been described as, for example, information for controlling the external device 30 or the mobile interaction robot 100 by binary so as to start or stop driving of the external device 30 or the mobile interaction robot 100, but it is not limited thereto. For example, the control information generating unit 22 may generate control information indicating different control contents on the basis of the number of times, a period, a position, or the like that a user's finger or the like touches a detection means to detect contact between the long object 120 and an object other than the long object 120 or the robots connected to the long object 120.

In addition, the control information generating unit 22 may generate control information for controlling either the mobile interaction robot 100 or the external device 30 on the basis of the number of times, a period, a position, or the like that a user's finger or the like touches a detection means to detect contact between the long object 120 and an object other than the long object 120 or the robots connected to the long object 120.

In addition, in the first embodiment, the robot system 1 has been described as, for example, a robot system including one external device 30, but it is not limited thereto. For example, the robot system 1 may include a plurality of external devices 30. When the robot system 1 includes the plurality of external devices 30, the control information generating unit 22 may determine an external device 30 to be controlled among the plurality of external devices 30 on the basis of the number of times, a period, a position, or the like that a users finger or the like touches a detection means to detect contact between the long object 120 and an object other than the long object 120 or the robots connected to the long object 120, and generate control information for controlling the external device 30.

In addition, in the first embodiment, the long object state detecting unit 130 has been described as a contact detecting means, but the long object state detecting unit 130 is not limited to the contact detecting means. For example, the long object state detecting unit 130 may be a detection means to detect an external force applied to the long object 120 (hereinafter, “external force detecting means”). The external force detecting means is constituted by, for example, a piezoelectric sensor. When a user pushes the long object 120 made of a plastic material, the long object state detecting unit 130 transmits a detection signal indicating an external force applied to the long object 120 to the information generating unit 140. The information generating unit 140 generates mobile interaction robot information by including information indicating an external force applied to the long object 120 corresponding to the strength of a detection signal received from the long object state detecting unit 130 in the mobile interaction robot information.

### Second Embodiment

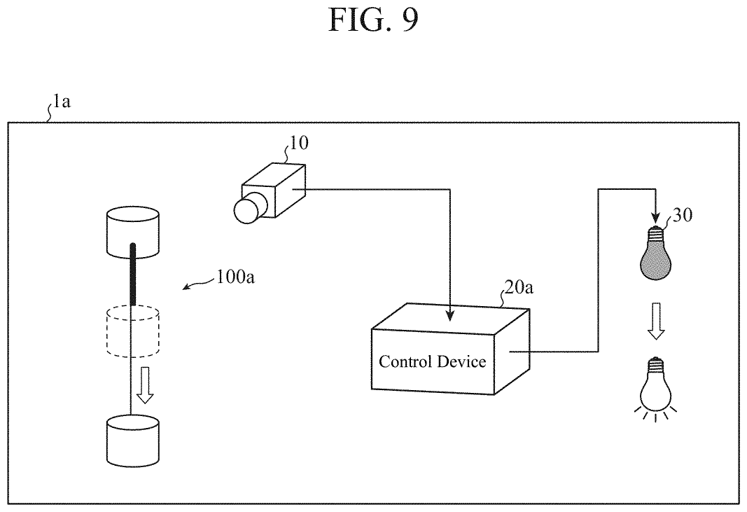

A mobile interaction robot 100a and a control device 20a according to a second embodiment will be described with reference to FIGS. 9 to 12.

FIG. 9 is a configuration diagram illustrating an example of a configuration of a main part of a robot system 1a to which the mobile interaction robot 100a and the control device 20a according to the second embodiment are applied.

The robot system 1a is obtained, in the robot system 1 according to the first embodiment, by changing the mobile interaction robot 100 and the control device 20 of the robot system 1 according to the first embodiment to the mobile interaction robot 100a and the control device 20a.

The robot system 1a includes the mobile interaction robot 100a, an imaging device 10, the control device 20a, and an external device 30.

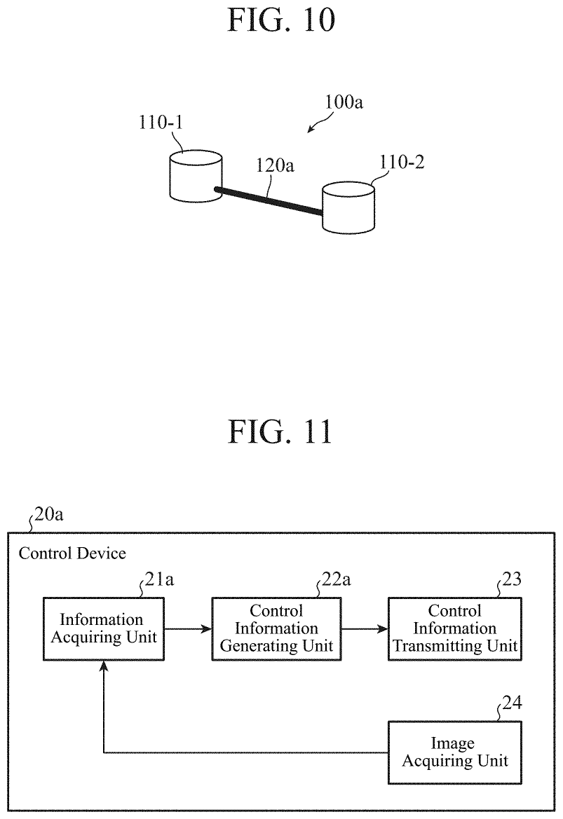

FIG. 10 is a configuration diagram illustrating an example of a configuration of a main part of the mobile interaction robot 100a according to the second embodiment.

The mobile interaction robot 100a is obtained, in the mobile interaction robot 100 according to the first embodiment illustrated in FIG. 3, by changing the long object 120, the long object state detecting unit 130, and the information generating unit 140 of the mobile interaction robot 100 illustrated in FIG. 3 to a long object 120a, a long object state detecting unit 130a (not illustrated), and an information generating unit 140a (not illustrated).

The mobile interaction robot 100a includes robots 110-1 and 110-2, the long object 120a, the long object state detecting unit 130a, the information generating unit 140a, and an information transmission controlling unit 150.

In the configuration of the robot system 1a according to the second embodiment, similar components to those of the robot system 1 according to the first embodiment are denoted by the same reference numerals, and redundant description will be omitted. That is, description of components of FIG. 9 denoted by the same reference numerals as those illustrated in FIG. 1 will be omitted.

In addition, in the configuration of the mobile interaction robot 100a according to the second embodiment, similar components to those of the mobile interaction robot 100 according to the first embodiment are denoted by the same reference numerals, and redundant description will be omitted. That is, description of components of FIG. 10 denoted by the same reference numerals as those illustrated in FIG. 2 will be omitted.

The long object 120a is a long object made of an elastic material, a plastic material, a cable member, or the like. One end of the long object 120a is connected to the robot 110-1, and the other end of the long object 120a is connected to the robot 110-2.

That is, the mobile interaction robot 100a is obtained by connecting the self-propelled robot 110-1 and the self-propelled robot 110-2 to each other by the long object 120a.

The long object 120a according to the second embodiment will be described below as being made of an elastic material such as a spring or an elastic resin.

The long object state detecting unit 130a is a detection means such as a sensor for detecting a state of the long object 120a. Specifically, the long object state detecting unit 130a is a detection means such as an external force sensor for detecting an external force applied to the long object 120a, a shape sensor for detecting the shape of the long object 120a, or a contact sensor for detecting contact between the long object 120a and an object other than the long object 120a or the robots 110-1 and 110-2 connected to the long object 120a. The long object state detecting unit 130a transmits a detection signal indicating the detected state of the long object 120a to the information generating unit 140a.

The long object state detecting unit 130a according to the second embodiment will be described as an external force sensor. The external force sensor is constituted by, for example, a piezoelectric sensor for detecting an external force applied to the long object 120a as an elastic force generated in the long object 120a. More specifically, the piezoelectric sensor which is the long object state detecting unit 130a is disposed, for example, at a position where the robot 110-1 or the robot 110-2 is connected to the long object 120a in the robot 110-1 or the robot 110-2 while being fixed to an end of the long object 120a. That is, the long object state detecting unit 130a according to the second embodiment is a detection means to detect the magnitude of tension or repulsive force generated between the long object 120a made of an elastic material and the robot 110-1 or the robot 110-2.

The information generating unit 140a receives a detection signal from the long object state detecting unit 130a, and generates mobile interaction robot information indicating a state of the long object 120a on the basis of the received detection signal.

The information generating unit 140a is included in the robot 110-1, the robot 110-2, or the long object 120a.

When the information generating unit 140a includes a detection means to detect the position, moving speed, moving direction, or the like of the robot 110-1, the robot 110-2, or the long object 120a, the mobile interaction robot information generated by the information generating unit 140a may include information indicating the position, moving speed, moving direction, or the like of the robot 110-1, the robot 110-2, or the long object 120a in addition to information indicating a state of the long object 120a.

The information transmission controlling unit 150 transmits the mobile interaction robot information generated by the information generating unit 140a to the control device 20a.

Note that the long object state detecting unit 130a, the information generating unit 140a, and the information transmission controlling unit 150 operate by receiving power supply from a power supply means (not illustrated) such as a battery included in the long object 120a, a power supply means (not illustrated) such as a battery included in the robot 110-1 or the robot 110-2, or the like.

In addition, the functions of the information generating unit 140a and the information transmission controlling unit 150 in the mobile interaction robot 100a are implemented by at least one of a processor and a memory, or a processing circuit. The processor and the memory or the processing circuit for implementing the functions of the information generating unit 140a and the information transmission controlling unit 150 in the mobile interaction robot 100a is included in the long object 120a, the robot 110-1, or the robot 110-2. Since the processor, the memory, and the processing circuit have been described above, description thereof will be omitted.

In addition, in the mobile interaction robot 100a, the information generating unit 140a is not an essential component, and the mobile interaction robot 100a does not have to include the information generating unit 140a. When the mobile interaction robot 100a does not include the information generating unit 140a, for example, the information transmission controlling unit 150 receives a detection signal from the long object state detecting unit 130a, and the information transmission controlling unit 150 transmits the received detection signal to the control device 20a using the detection signal as mobile interaction robot information.

The control device 20a acquires mobile interaction robot information indicating a state of the mobile interaction robot 100a, and controls a control target on the basis of the acquired mobile interaction robot information.

The control target controlled by the control device 20a is the mobile interaction robot 100a, or the mobile interaction robot 100a and the external device 30.

A configuration of a main part of the control device 20a according to the second embodiment will be described with reference to FIG. 11.

FIG. 11 is a block diagram illustrating an example of a configuration of a main part of the control device 20a according to the second embodiment.

The control device 20a is obtained, in the control device 20 according to the first embodiment, by changing the information acquiring unit 21 and the control information generating unit 22 in the control device 20 according to the first embodiment to an information acquiring unit 21a and a control information generating unit 22a.

The control device 20a includes the information acquiring unit 21a, the control information generating unit 22a, a control information transmitting unit 23, and an image acquiring unit 24.

In addition, in the configuration of the control device 20a according to the second embodiment, similar components to those of the control device 20 according to the first embodiment are denoted by the same reference numerals, and redundant description will be omitted. That is, description of components of FIG. 11 denoted by the same reference numerals as those illustrated in FIG. 4 will be omitted.

The information acquiring unit 21a acquires mobile interaction robot information indicating a state of the mobile interaction robot 100a.

Specifically, the information acquiring unit 21a acquires mobile interaction robot information by receiving mobile interaction robot information transmitted by the mobile interaction robot 100a.

More specifically, the information acquiring unit 21a acquires mobile interaction robot information indicating a state of the mobile interaction robot 100a, such as the position, moving speed, moving direction, or the like of the robot 110-1 included in the mobile interaction robot 100a, the position, moving speed, moving direction, or the like of the robot 110-2 included in the mobile interaction robot 100a, or the position, moving speed, moving direction, state, or the like of the long object 120a included in the mobile interaction robot 100a.

In addition, the information acquiring unit 21a may include an image analysis means, and may acquire mobile interaction robot information by analyzing image information acquired by the image acquiring unit 24 from the imaging device 10.

More specifically, by analyzing the image information acquired by the image acquiring unit 24 from the imaging device 10, the information acquiring unit 21a acquires mobile interaction robot information indicating a state of the mobile interaction robot 100a, such as the position, moving speed, moving direction, or the like of the robot 110-1 included in the mobile interaction robot 100a, the position, moving speed, moving direction, or the like of the robot 110-2 included in the mobile interaction robot 100a, or the position, moving speed, moving direction, state, or the like of the long object 120a included in the mobile interaction robot 100.

When the imaging device 10 captures an image of the external device 30, a user, or the like in addition to an image of the mobile interaction robot 100a, by analyzing the image information acquired by the image acquiring unit 24 from the imaging device 10, the information acquiring unit 21a may acquire information indicating a relative position of the mobile interaction robot 100a, or the robot 110-1, the robot 110-2, or the long object 120a included in the mobile interaction robot 100a with respect to the external device 30, the user, or the like as mobile interaction robot information.

Note that, when it is not configured in such a manner that the information acquiring unit 21a acquires mobile interaction robot information indicating a state of the mobile interaction robot 100a, such as the position, moving speed, moving direction, or the like of the robot 110-1 included in the mobile interaction robot 100a, the position, moving speed, moving direction, or the like of the robot 110-2, or the position, moving speed, moving direction, state, or the like of the long object 120a, and by analyzing the image information acquired by the image acquiring unit 24 from the imaging device 10, the information acquiring unit 21a acquires information indicating a relative position of the mobile interaction robot 100a, or the robot 110-1, the robot 110-2, or the long object 120a included in the mobile interaction robot 100a with respect to the external device 30, the user, or the like as mobile interaction robot information, the imaging device 10 and the image acquiring unit 24 are not essential components.

The control information generating unit 22a generates control information for controlling a control target on the basis of the mobile interaction robot information acquired by the information acquiring unit 21a.

For example, the control information generating unit 22a generates control information for controlling the mobile interaction robot 100a on the basis of the mobile interaction robot information acquired by the information acquiring unit 21a.

Specifically, the control information generating unit 22a generates control information for controlling travel of the robot 110-1 and the robot 110-2 included in the mobile interaction robot 100a on the basis of the mobile interaction robot information acquired by the information acquiring unit 21a.

More specifically, the control information generating unit 22a generates control information for controlling travel of the robot 110-1 and the robot 110-2 on the basis of the position, moving speed, moving direction, or the like of the robot 110-1, the position, moving speed, moving direction, or the like of the robot 110-2, or the position, moving speed, moving direction, state, or the like of the long object 120a, indicated by the mobile interaction robot information.

In addition, for example, the control information generating unit 22a may generate control information for controlling the external device 30 on the basis of the mobile interaction robot information in addition to the control information for controlling the mobile interaction robot 100a.

The control information transmitting unit 23 transmits the control information generated by the control information generating unit 22a to the mobile interaction robot 100a or the external device 30 as a control target.

Note that the functions of the information acquiring unit 21a, the control information generating unit 22a, the control information transmitting unit 23, and the image acquiring unit 24 in the control device 20a according to the second embodiment may be implemented by the processor 501 and the memory 502 in the hardware configuration exemplified in FIGS. 5A and 5B in the first embodiment, or may be implemented by the processing circuit 503.

The external device 30 according to the second embodiment will be described as a dimmable illumination device. Note that the illumination device is merely an example, and the external device 30 is not limited to the illumination device.

HCI according to the second embodiment will be described.

In third HCI according to the second embodiment, the external device 30 is controlled by applying an external force to the long object 120a by an operation of directly applying a force to the long object 120a of the mobile interaction robot 100a or by an operation of manually moving the robot 110-1 or the robot 110-2, or the like. Specifically, for example, in the third HCI, illuminance of the illumination device which is the external device 30 is controlled so as to be changed depending on the magnitude of an external force applied to the long object 120a when a user applies the external force to the long object 120a.

When a user performs an operation of directly applying a force to the long object 120a of the mobile interaction robot 100a, an operation of manually moving the robot 110-1 or the robot 110-2, or the like, the long object state detecting unit 130a in the mobile interaction robot 100a detects the magnitude of an external force applied to the long object 120a as the magnitude of an elastic force generated in the long object 120a. The information generating unit 140a in the mobile interaction robot 100a generates information indicating the magnitude of an external force applied to the long object 120a as mobile interaction robot information indicating a state of the long object 120a. The information transmission controlling unit 150 in the mobile interaction robot 100a transmits the mobile interaction robot information generated by the information generating unit 140a to the control device 20a.

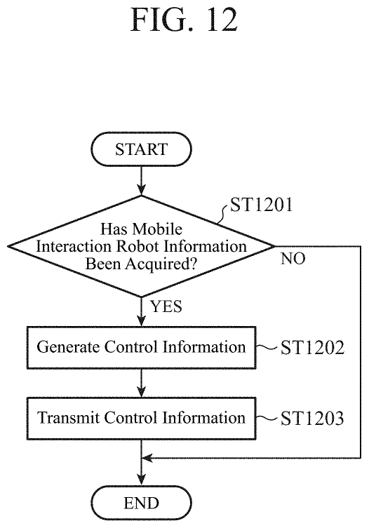

FIG. 12 is a flowchart for explaining an example of processing of the control device 20a according to the second embodiment. The control device 20a repeatedly executes the processing of the flowchart.

First, in step ST1201, the information acquiring unit 21a determines whether or not mobile interaction robot information has been acquired from the mobile interaction robot 100a.

In step ST1201, if the information acquiring unit 21a determines that mobile interaction robot information has not been acquired from the mobile interaction robot 100a, the control device 20a ends the processing of the flowchart, returns to step ST1201, and repeatedly executes the processing of the flowchart.

In step ST1201, if the information acquiring unit 21a determines that mobile interaction robot information has been acquired from the mobile interaction robot 100a, in step ST1202, the control information generating unit 22a generates control information for controlling the illumination device which is the external device 30 on the basis of the mobile interaction robot information.

After step ST1202, in step ST1203, the control information transmitting unit 23 transmits the control information generated by the control information generating unit 22a to the external device 30.

After step ST1203, the control device 20a ends the processing of the flowchart, returns to step ST1201, and repeatedly executes the processing of the flowchart.

The external device 30 acquires the control information transmitted by the control device 20a and operates on the basis of the acquired control information. Specifically, for example, the illumination device which is the external device 30 changes illuminance on the basis of the control information.

As described above, in the mobile interaction robot 100a, a plurality of self-propelled robots is connected to each other by the long object 120a.

With this configuration, the mobile interaction robot 100a can provide a wide variety of HCI.

In addition, in the above-described configuration, the long object 120a included in the mobile interaction robot 100a is made of an elastic material.

With this configuration, the mobile interaction robot 100a can provide a wide variety of HCI.

In addition, the mobile interaction robot 100a includes the long object state detecting unit 130a for detecting a state of the long object 120a in addition to the above-described configuration.

With this configuration, the mobile interaction robot 100a can provide a wide variety of HCI depending on a state of the long object 120a.

In addition, in the above-described configuration, the long object state detecting unit 130a included in the mobile interaction robot 100a detects an external force applied to the long object 120a.

With this configuration, the mobile interaction robot 100a can provide a wide variety of HCI depending on an external force applied to the long object 120a.

In addition, the control device 20a includes the information acquiring unit 21a for acquiring mobile interaction robot information indicating a state of the mobile interaction robot 100a, and the control information generating unit 22a for generating control information for controlling a control target on the basis of the mobile interaction robot information acquired by the information acquiring unit 21a.

With this configuration, the control device 20a can provide a wide variety of HCI.

In addition, with this configuration, the control device 20a can cause the external device 30 as a control target to perform a desired operation depending on a state of the mobile interaction robot 100a.

In addition, in the above-described configuration, the mobile interaction robot information acquired by the information acquiring unit 21a included in the control device 20a includes information indicating the position of the mobile interaction robot 100a.

With this configuration, the control device 20a can provide a wide variety of HCI.

In addition, with this configuration, the control device 20a can accurately control travel of the plurality of robots 110-1 and 110-2 included in the mobile interaction robot 100a as a control target depending on the position of the mobile interaction robot 100a, and can accurately move the mobile interaction robot 100a.

In addition, in the above-described configuration, the information indicating a position included in the mobile interaction robot information acquired by the information acquiring unit 21a included in the control device 20a includes information indicating the position of each of the plurality of robots 110-1 and 110-2 included in the mobile interaction robot 100a.

With this configuration, the control device 20a can provide a wide variety of HCI.

In addition, with this configuration, the control device 20a can accurately control travel of the plurality of robots 110-1 and 110-2 included in the mobile interaction robot 100a as a control target depending on the positions of the plurality of robots 110-1 and 110-2 included in the mobile interaction robot 100a, and can accurately move the mobile interaction robot 100a.

In addition, in the above-described configuration, the information indicating a position included in the mobile interaction robot information acquired by the information acquiring unit 21a included in the control device 20a includes information indicating the position of the long object 120a included in the mobile interaction robot 100a.

With this configuration, the control device 20a can provide a wide variety of HCI.

In addition, with this configuration, the control device 20a can accurately control travel of the plurality of robots 110-1 and 110-2 included in the mobile interaction robot 100a as a control target depending on the position of the long object 120a included in the mobile interaction robot 100a, and can accurately move the mobile interaction robot 100a.

In addition, in the above-described configuration, the mobile interaction robot information acquired by the information acquiring unit 21a included in the control device 20a includes information indicating an external force applied to the long object 120a included in the mobile interaction robot 100a.

With this configuration, the control device 20a can provide a wide variety of HCI.

In addition, with this configuration, the control device 20a can cause the external device 30 as a control target to perform a desired operation depending on an external force applied to the long object 120a included in the mobile interaction robot 100a.

In addition, in the above-described configuration, the control information generated by the control information generating unit 22a included in the control device 20a is control information for controlling the external device 30, and the control information generating unit 22a generates the control information for controlling the external device 30 on the basis of the mobile interaction robot information acquired by the information acquiring unit 21a.

With this configuration, the control device 20a can provide a wide variety of HCI.

In addition, with this configuration, the control device 20a can cause the external device 30 as a control target to perform a desired operation depending on a state of the mobile interaction robot 100a.

Note that, in the second embodiment, the external device 30 has been described as, for example, an illumination device, but the external device 30 is not limited to the illumination device. The external device 30 may be an electronic device such as an information device, a display control device, or an acoustic device, or a device such as a machine driven by electronic control.

In addition, in the second embodiment, the control information generating unit 22a has been described as a unit for generating control information on the basis of the magnitude of an external force applied to the long object 120a, but it is not limited thereto. The control information generating unit 22a may generate control information on the basis of a change in magnitude of an external force applied to the long object 120a per unit time, a cycle of the external force applied to the long object 120a, a direction of the external force applied to the long object 120a, and the like.

In addition, in the second embodiment, an example has been described in which the control information generating unit 22a generates control information for controlling the external device 30 on the basis of an external force applied to the long object 120a, but it is not limited thereto. The control information generating unit 22a may generate control information for controlling the mobile interaction robot 100a on the basis of an external force applied to the long object 120a.

In addition, in the second embodiment, the robot system 1a has been described as, for example, a robot system including one external device 30, but it is not limited thereto. For example, the robot system 1a may include a plurality of external devices 30. When the robot system 1a includes a plurality of external devices 30, the control information generating unit 22a may determine an external device 30 to be controlled among the plurality of external devices 30 on the basis of the magnitude of an external force applied to the long object 120a, a change in the magnitude of the external force applied to the long object 120a per unit time, a period of the external force applied to the long object 120a, a direction of the external force applied to the long object 120a, and the like, and generate control information for controlling the external device 30.

In addition, the mobile interaction robot 100a described above has been described as a mobile interaction robot including the two self-propelled robots 110-1 and 110-2, in which the two self-propelled robots 110-1 and 110-2 are connected to each other by the long object 120a. However, for example, similarly to the mobile interaction robot 100 illustrated in FIG. 8, the mobile interaction robot 100a may be a mobile interaction robot including three or more self-propelled robots, in which the three or more self-propelled robots are connected to each other by the long object 120a.

### Third Embodiment

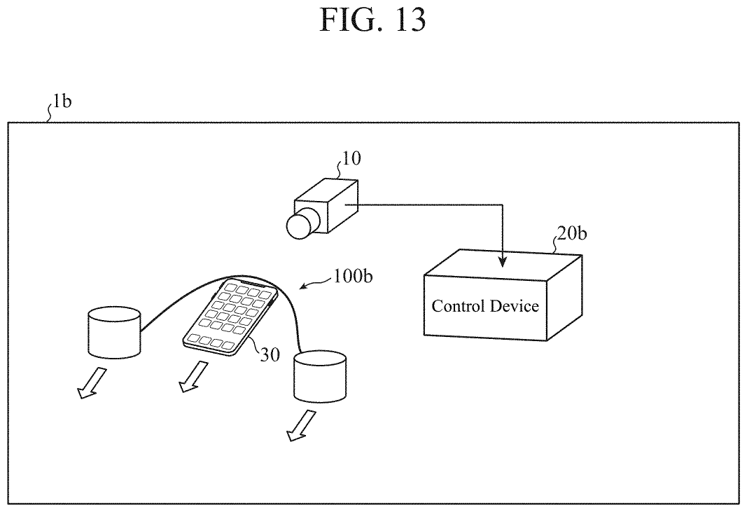

A mobile interaction robot 100b and a control device 20b according to a third embodiment will be described with reference to FIGS. 13 to 16.

FIG. 13 is a configuration diagram illustrating an example of a configuration of a main part of a robot system 1b to which the mobile interaction robot 100b and the control device 20b according to the third embodiment are applied.

The robot system 1b is obtained, in the robot system 1 according to the first embodiment, by changing the mobile interaction robot 100 and the control device 20 of the robot system 1 according to the first embodiment to the mobile interaction robot 100b and the control device 20b.

The robot system 1b includes the mobile interaction robot 100b, an imaging device 10, the control device 20b, and an external device 30.

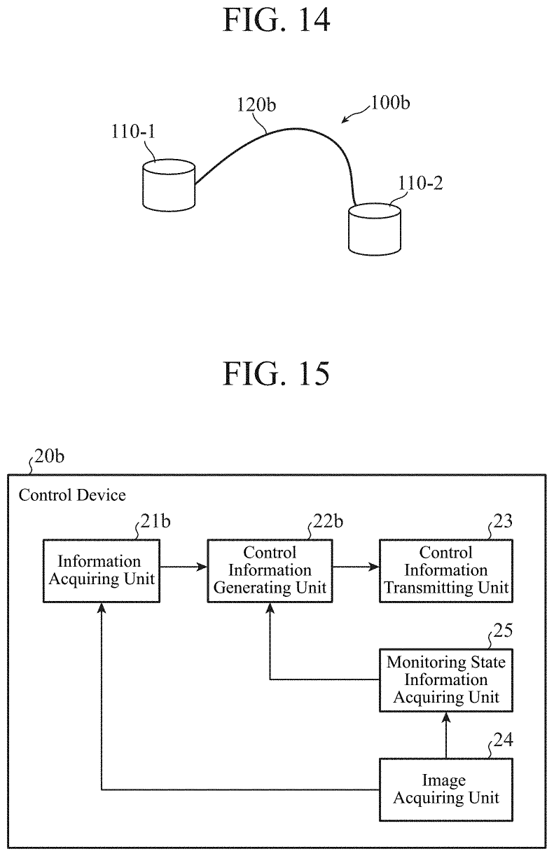

FIG. 14 is a configuration diagram illustrating an example of a configuration of a main part of the mobile interaction robot 100b according to the third embodiment.

The mobile interaction robot 100b is obtained, in the mobile interaction robot 100 according to the first embodiment illustrated in FIG. 3, by changing the long object 120, the long object state detecting unit 130, and the information generating unit 140 of the mobile interaction robot 100 illustrated in FIG. 3 to a long object 120b, a long object state detecting unit 130b (not illustrated), and an information generating unit 140b (not illustrated).

The mobile interaction robot 100b includes robots 110-1 and 110-2, the long object 120b, the long object state detecting unit 130b, the information generating unit 140b, and an information transmission controlling unit 150.

In the configuration of the robot system 1b according to the third embodiment, similar components to those of the robot system 1 according to the first embodiment are denoted by the same reference numerals, and redundant description will be omitted. That is, description of components of FIG. 13 denoted by the same reference numerals as those illustrated in FIG. 1 will be omitted.

In addition, in the configuration of the mobile interaction robot 100b according to the third embodiment, similar components to those of the mobile interaction robot 100 according to the first embodiment are denoted by the same reference numerals, and redundant description will be omitted. That is, description of components of FIG. 14 denoted by the same reference numerals as those illustrated in FIG. 2 will be omitted.

The long object 120b is along object made of an elastic material, a plastic material, a cable member, or the like. One end of the long object 120b is connected to the robot 110-1, and the other end of the long object 120b is connected to the robot 110-2.

That is, the mobile interaction robot 100b is obtained by connecting the self-propelled robot 110-1 and the self-propelled robot 110-2 to each other by the long object 120b.

The long object 120b according to the third embodiment will be described below as being made of a cable member such as a string or a wire.

The long object state detecting unit 130b is a detection means such as a sensor for detecting a state of the long object 120b. Specifically, the long object state detecting unit 130b is a detection means such as an external force sensor for detecting an external force applied to the long object 120b, a shape sensor for detecting the shape of the long object 120b, or a contact sensor for detecting contact between the long object 120b and an object other than the long object 120b or the robots 110-1 and 110-2 connected to the long object 120b. The long object state detecting unit 130b transmits a detection signal indicating the detected state of the long object 120b to the information generating unit 140b.

The long object state detecting unit 130b according to the third embodiment will be described as an external force sensor. The external force sensor is constituted by, for example, a piezoelectric sensor for detecting an external force applied to the long object 120b as an elastic force generated in the long object 120b. More specifically, the piezoelectric sensor which is the long object state detecting unit 130b is disposed, for example, at a position where the robot 110-1 or the robot 110-2 is connected to the long object 120b in the robot 110-1 or the robot 110-2 while being fixed to an end of the long object 120b. That is, the long object state detecting unit 130b according to the third embodiment is a detection means to detect the magnitude of tension or repulsive force generated between the long object 120b made of a cable member and the robot 110-1 or the robot 110-2.

The information generating unit 140b receives a detection signal from the long object state detecting unit 130b, and generates mobile interaction robot information indicating a state of the long object 120b on the basis of the received detection signal.

The information generating unit 140b is included in the robot 110-1, the robot 110-2, or the long object 120b.

When the information generating unit 140b includes a detection means to detect the position, moving speed, moving direction, or the like of the robot 110-1, the robot 110-2, or the long object 120b, the mobile interaction robot information generated by the information generating unit 140b may include information indicating the position, moving speed, moving direction, or the like of the robot 110-1, the robot 110-2, or the long object 120b in addition to information indicating a state of the long object 120b.

The information transmission controlling unit 150 transmits the mobile interaction robot information generated by the information generating unit 140b to the control device 20b.

Note that the long object state detecting unit 130b, the information generating unit 140b, and the information transmission controlling unit 150 operate by receiving power supply from a power supply means (not illustrated) such as a battery included in the long object 120b, a power supply means (not illustrated) such as a battery included in the robot 110-1 or the robot 110-2, or the like.

In addition, the functions of the information generating unit 140b and the information transmission controlling unit 150 in the mobile interaction robot 100b are implemented by at least one of a processor and a memory, or a processing circuit. The processor and the memory or the processing circuit for implementing the functions of the information generating unit 140b and the information transmission controlling unit 150 in the mobile interaction robot 100b is included in the long object 120b, the robot 110-1, or the robot 110-2. Since the processor, the memory, and the processing circuit have been described above, description thereof will be omitted.

In addition, in the mobile interaction robot 10b, the information generating unit 140b is not an essential component, and the mobile interaction robot 100b does not have to include the information generating unit 140b. When the mobile interaction robot 100b does not include the information generating unit 140b, for example, the information transmission controlling unit 150 receives a detection signal from the long object state detecting unit 130b, and the information transmission controlling unit 150 transmits the received detection signal to the control device 20b using the detection signal as mobile interaction robot information.

The control device 20b acquires mobile interaction robot information indicating a state of the mobile interaction robot 100b, and controls a control target on the basis of the acquired mobile interaction robot information.

The control target controlled by the control device 20b is the mobile interaction robot 100b, or the mobile interaction robot 100b and the external device 30.

A configuration of a main part of the control device 20b according to the third embodiment will be described with reference to FIG. 15.

FIG. 15 is a block diagram illustrating an example of a configuration of a main part of the control device 20b according to the third embodiment.

The control device 20b is obtained by, in the control device 20 according to the first embodiment, changing the information acquiring unit 21 and the control information generating unit 22 in the control device 20 according to the first embodiment to an information acquiring unit 21b and a control information generating unit 22b and further adding a monitoring state information acquiring unit 25.

The control device 20b includes the information acquiring unit 21b, the control information generating unit 22b, a control information transmitting unit 23, an image acquiring unit 24, and the monitoring state information acquiring unit 25.

In the configuration of the control device 20b according to the third embodiment, similar components to those of the control device 20 according to the first embodiment are denoted by the same reference numerals, and redundant description will be omitted. That is, description of components of FIG. 15 denoted by the same reference numerals as those illustrated in FIG. 4 will be omitted.

The information acquiring unit 21b acquires mobile interaction robot information indicating a state of the mobile interaction robot 100b.

Specifically, the information acquiring unit 21b acquires mobile interaction robot information by receiving mobile interaction robot information transmitted by the mobile interaction robot 100b.

More specifically, the information acquiring unit 21b acquires mobile interaction robot information indicating a state of the mobile interaction robot 100b, such as the position, moving speed, moving direction, or the like of the robot 110-1 included in the mobile interaction robot 100b, the position, moving speed, moving direction, or the like of the robot 110-2 included in the mobile interaction robot 100b, or the position, moving speed, moving direction, state, or the like of the long object 120b included in the mobile interaction robot 100b.

In addition, the information acquiring unit 21b may include an image analysis means, and may acquire mobile interaction robot information by analyzing image information acquired by the image acquiring unit 24 from the imaging device 10.

More specifically, by analyzing the image information acquired by the image acquiring unit 24 from the imaging device 10, the information acquiring unit 21b acquires mobile interaction robot information indicating a state of the mobile interaction robot 100b, such as the position, moving speed, moving direction, or the like of the robot 110-1 included in the mobile interaction robot 100b, the position, moving speed, moving direction, or the like of the robot 110-2 included in the mobile interaction robot 100b, or the position, moving speed, moving direction, state, or the like of the long object 120b included in the mobile interaction robot 100b.

When the imaging device 10 captures an image of the external device 30, a user, or the like in addition to an image of the mobile interaction robot 100b, by analyzing the image information acquired by the image acquiring unit 24 from the imaging device 10, the information acquiring unit 21b may acquire information indicating a relative position of the mobile interaction robot 100b, or the robot 110-1, the robot 110-2, or the long object 120b included in the mobile interaction robot 100b with respect to the external device 30, the user, or the like as mobile interaction robot information.

The monitoring state information acquiring unit 25 acquires monitoring state information indicating a state of a monitoring target.

The monitoring target to be monitored by the control device 20b is, for example, the external device 30, a clock (not illustrated) that measures time or elapsed time, or a sensor (not illustrated) that measures environmental illuminance, environmental sound, or the like.

Specifically, for example, the monitoring state information acquiring unit 25 includes an image analysis means, and acquires, as monitoring state information, information indicating a state of the external device 30 as a monitoring target by analyzing image information acquired by the image acquiring unit 24 from the imaging device 10. The monitoring state information acquiring unit 25 may acquire the monitoring state information by receiving the monitoring state information output from the external device 30 as a monitoring target from the external device 30 via a wireless communication means such as Bluetooth (registered trademark) or Wi-Fi (registered trademark).

In addition, for example, the monitoring state information acquiring unit 25 may acquire the monitoring state information by receiving a sensor signal output from a sensor that measures environmental illuminance, environmental sound, or the like via a wired communication means or a wireless communication means, and generating the monitoring state information using the received sensor signal.

In addition, for example, the monitoring state information acquiring unit 25 may have a clock function and acquire the monitoring state information by generating the monitoring state information using time information output from the clock function.

The control information generating unit 22b generates control information for controlling a control target on the basis of the monitoring state information acquired by the monitoring state information acquiring unit 25 and the mobile interaction robot information acquired by the information acquiring unit 21b.

For example, the control information generating unit 22b generates control information for controlling the mobile interaction robot 100b on the basis of the monitoring state information acquired by the monitoring state information acquiring unit 25 and the mobile interaction robot information acquired by the information acquiring unit 21b.

Specifically, the control information generating unit 22b generates control information for controlling travel of the robot 110-1 and the robot 110-2 included in the mobile interaction robot 100b on the basis of the monitoring state information acquired by the monitoring state information acquiring unit 25 and the mobile interaction robot information acquired by the information acquiring unit 21b.

More specifically, the control information generating unit 22b generates control information for controlling travel of the robot 110-1 and the robot 110-2 on the basis of a state of a monitoring target indicated by the monitoring state information, the position, moving speed, moving direction, or the like of the robot 110-1, the position, moving speed, moving direction, or the like of the robot 110-2, or the position, moving speed, moving direction, state, or the like of the long object 120b, indicated by the mobile interaction robot information.

In addition, for example, the control information generating unit 22b may generate control information for controlling the external device 30 on the basis of the monitoring state information and the mobile interaction robot information in addition to the control information for controlling the mobile interaction robot 100b.

The control information transmitting unit 23 transmits the control information generated by the control information generating unit 22b to the mobile interaction robot 100b or the external device 30 as a control target.

Note that the functions of the information acquiring unit 21b, the control information generating unit 22b, the control information transmitting unit 23, the image acquiring unit 24, and the monitoring state information acquiring unit 25 in the control device 20b according to the third embodiment may be implemented by the processor 501 and the memory 502 in the hardware configuration exemplified in FIGS. 5A and 5B in the first embodiment, or may be implemented by the processing circuit 503.

A monitoring target according to the third embodiment will be described as the external device 30.

In addition, the external device 30 according to the third embodiment will be described as a mobile phone such as a smartphone. Note that the mobile phone is merely an example, and the external device 30 is not limited to the mobile phone.

HCI according to the third embodiment will be described.

In fourth HCI according to the third embodiment, the mobile interaction robot 100b as a control target is controlled when a state change such as an incoming call, mail reception, or a remaining battery level decrease occurs in a mobile phone as a monitoring target.

Specifically, for example, in the fourth HCI, travel of the robot 110-1 and the robot 110-2 included in the mobile interaction robot 100b as a control target is controlled so as to move a mobile phone as a monitoring target to a predetermined position such as a position where a user can easily hold the mobile phone when a state change occurs in the mobile phone.

The position of the mobile phone is acquired, for example, when the information acquiring unit 21b analyzes image information including the mobile phone acquired by the image acquiring unit 24 from the imaging device 10. The information acquiring unit 21b generates and acquires information indicating the position of the mobile phone as mobile interaction robot information.

The predetermined position is, for example, a position determined in advance. The predetermined position is not limited to a position determined in advance. For example, the information acquiring unit 21b may acquire a position where a user is present by analyzing image information including the user acquired by the image acquiring unit 24 from the imaging device 10, and the predetermined position may be determined on the basis of the position where the user is present.

When a state change occurs in a mobile phone as a monitoring target, the control information generating unit 22b generates control information for causing the robot 110-1 and the robot 110-2 to travel to a position where the long object 120b included in the mobile interaction robot 100b as a control target comes into contact with the mobile phone.

After the long object 120b comes into contact with the mobile phone, the control information generating unit 22b generates control information for causing the robot 110-1 and the robot 110-2 to travel in such a manner that the mobile interaction robot 100b hooks an outer periphery of the mobile phone with the long object 120b and drags and moves the mobile phone to a predetermined position.

When the mobile interaction robot 100b drags and moves the mobile phone, tension acts on the long object 120b. The long object state detecting unit 130b in the mobile interaction robot 100b detects the magnitude of an external force applied to the long object 120b as the magnitude of an external force generated in the long object 120b. The information generating unit 140b in the mobile interaction robot 100b generates mobile interaction robot information indicating the magnitude of the external force applied to the long object 120b as mobile interaction robot information indicating a state of the long object 120b. The information transmission controlling unit 150 in the mobile interaction robot 100b transmits the mobile interaction robot information generated by the information generating unit 140b to the control device 20b.

The information acquiring unit 21b in the control device 20b acquires the mobile interaction robot information indicating the magnitude of an external force applied to the long object 120b. When generating control information for the mobile interaction robot 100b to drag and move the mobile phone, for example, the control information generating unit 22b generates control information for causing the robot 110-1 and the robot 110-2 to travel in such a manner that the magnitude of an external force applied to the long object 120b indicated by the mobile interaction robot information is a predetermined magnitude.

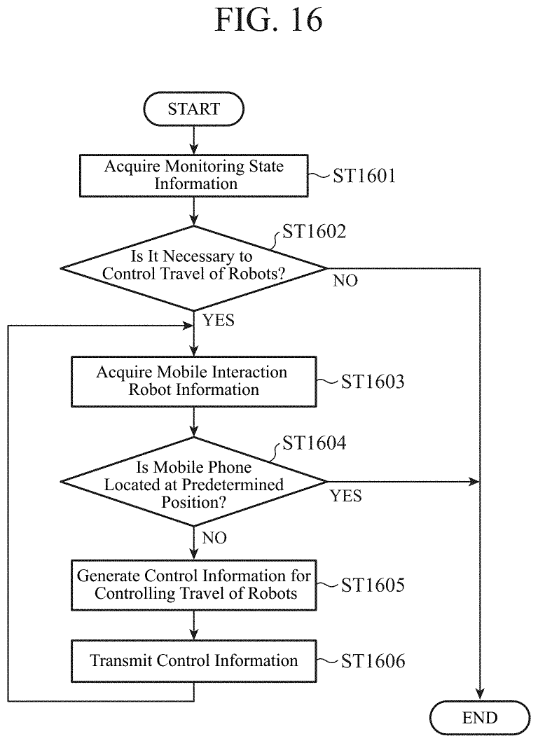

FIG. 16 is a flowchart for explaining an example of processing of the control device 20b according to the third embodiment. The control device 20b repeatedly executes the processing of the flowchart.

First, in step ST1601, the monitoring state information acquiring unit 25 acquires monitoring state information.

After step ST1601, in step ST1602, the control information generating unit 22b determines whether or not it is necessary to control travel of the robot 110-1 and the robot 110-2 included in the mobile interaction robot 100b as a control target on the basis of the monitoring state information acquired by the monitoring state information acquiring unit 25.

In step ST1602, if the control information generating unit 22b determines that it is not necessary to control travel of the robot 110-1 and the robot 110-2 included in the mobile interaction robot 100b as a control target, the control device 20b ends the processing of the flowchart, returns to step ST1601, and repeatedly executes the processing of the flowchart.

In step ST1602, if the control information generating unit 22b determines that it is necessary to control travel of the robot 110-1 and the robot 110-2 included in the mobile interaction robot 100b as a control target, in step ST1603, the control information generating unit 22b causes the information acquiring unit 21b to acquire mobile interaction robot information.

After step ST1603, in step ST1604, the control information generating unit 22b determines whether or not the mobile phone as a monitoring target is located at a predetermined position on the basis of the mobile interaction robot information acquired by the information acquiring unit 21b.

In step ST1604, if the control information generating unit 22b determines that the mobile phone as a monitoring target is located at the predetermined position, the control device 20b ends the processing of the flowchart, returns to step ST1601, and repeatedly executes the processing of the flowchart.

In step ST1604, if the control information generating unit 22b determines that the mobile phone as a monitoring target is not located at the predetermined position, in step ST1605, the control information generating unit 22b generates control information for controlling travel of the robot 110-1 and the robot 110-2 included in the mobile interaction robot 100b as a control target so as to move the mobile phone toward the predetermined position.

After step ST1605, in step ST1606, the control information transmitting unit 23 transmits the control information generated by the control information generating unit 22b to the mobile interaction robot 100b.

After step ST1605, the control device 20b returns to step ST1603 and repeatedly executes the processing of step ST1603 to step ST1606 until the mobile phone as a monitoring target is located at the predetermined position.

As described above, in the mobile interaction robot 100b, a plurality of self-propelled robots is connected to each other by the long object 120b.

With this configuration, the mobile interaction robot 100b can provide a wide variety of HCI.

In addition, in the above-described configuration, the long object 120b included in the mobile interaction robot 100b is made of a cable member.

With this configuration, the mobile interaction robot 100b can provide a wide variety of HCI.

In addition, with this configuration, in the mobile interaction robot 100b, an external force can be applied to the external device 30 not only by the robots 110-1 and 110-2 but also by the long object 120b.

In addition, the mobile interaction robot 100b includes the long object state detecting unit 130b for detecting a state of the long object 120b in addition to the above-described configuration.

With this configuration, the mobile interaction robot 100b can provide a wide variety of HCI.

In addition, with this configuration, the mobile interaction robot 100b can accurately apply an external force to the external device 30 depending on not only states of the robots 110-1 and 110-2 but also a state of the long object 120b.

In addition, in the above-described configuration, the long object state detecting unit 130b included in the mobile interaction robot 100b detects an external force applied to the long object 120b.

With this configuration, the mobile interaction robot 100b can provide a wide variety of HCI.

In addition, with this configuration, the mobile interaction robot 100b can accurately apply an external force to the external device 30 depending on an external force applied to the long object 120b.

In addition, the control device 20b includes the information acquiring unit 21b for acquiring mobile interaction robot information indicating a state of the mobile interaction robot 100b, and the control information generating unit 22b for generating control information for controlling a control target on the basis of the mobile interaction robot information acquired by the information acquiring unit 21b.

With this configuration, the control device 20b can provide a wide variety of HCI.

In addition, with this configuration, the control device 20b can move the mobile interaction robot 100b as a control target depending on a state of the mobile interaction robot 100b.

In addition, in the above-described configuration, the mobile interaction robot information acquired by the information acquiring unit 21b included in the control device 20b includes information indicating the position of the mobile interaction robot 100b.

With this configuration, the control device 20b can provide a wide variety of HCI.

In addition, with this configuration, the control device 20b can accurately control travel of the plurality of robots 110-1 and 110-2 included in the mobile interaction robot 100b as a control target depending on the position of the mobile interaction robot 100b, and can accurately move the mobile interaction robot 100b.

In addition, in the above-described configuration, the information indicating a position included in the mobile interaction robot information acquired by the information acquiring unit 21b included in the control device 20b includes information indicating the position of each of the plurality of robots 110-1 and 110-2 included in the mobile interaction robot 100b.

With this configuration, the control device 20b can provide a wide variety of HCI.

In addition, with this configuration, the control device 20b can accurately control travel of the plurality of robots 110-1 and 110-2 included in the mobile interaction robot 100b as a control target depending on the positions of the plurality of robots 110-1 and 110-2 included in the mobile interaction robot 100b, and can accurately move the mobile interaction robot 100b.

In addition, in the above-described configuration, the information indicating a position included in the mobile interaction robot information acquired by the information acquiring unit 21b included in the control device 20b includes information indicating the position of the long object 120b included in the mobile interaction robot 100b.

With this configuration, the control device 20b can provide a wide variety of HCI.

In addition, with this configuration, the control device 20b can accurately control travel of the plurality of robots 110-1 and 110-2 included in the mobile interaction robot 100b as a control target depending on the position of the long object 120b included in the mobile interaction robot 100b, and can accurately move the mobile interaction robot 100b.

In addition, in the above-described configuration, the mobile interaction robot information acquired by the information acquiring unit 21b included in the control device 20b includes information indicating an external force applied to the long object 120b included in the mobile interaction robot 100b.

With this configuration, the control device 20b can provide a wide variety of HCI.

In addition, with this configuration, the control device 20b can accurately control travel of the robots 110-1 and 110-2 included in the mobile interaction robot 100b as a control target depending on an external force applied to the long object 120b included in the mobile interaction robot 100b.

In addition, with this configuration, the control device 20b can move the external device 30 by accurately moving the mobile interaction robot 100b depending on an external force applied to the long object 120b included in the mobile interaction robot 100b.

In addition, in the above-described configuration, the control information generated by the control information generating unit 22b included in the control device 20b is control information for controlling the mobile interaction robot 100b as a control target, and the control information generating unit 22b generates control information for controlling travel of the plurality of robots 110-1 and 110-2 included in the mobile interaction robot 100b on the basis of the mobile interaction robot information acquired by the information acquiring unit 21b.

With this configuration, the control device 20b can provide a wide variety of HCI.

In addition, with this configuration, the control device 20b can accurately control travel of the robots 110-1 and 110-2 included in the mobile interaction robot 100b as a control target depending on a state of the mobile interaction robot 100b.

In addition, with this configuration, the control device 20b can move the external device 30 by accurately moving the mobile interaction robot 100b depending on a state of the mobile interaction robot 100b.

In addition, the control device 20b includes the monitoring state information acquiring unit 25 for acquiring monitoring state information indicating a state of a monitoring target in addition to the above-described configuration, and the control information generated by the control information generating unit 22b is control information for controlling the mobile interaction robot 10b as a control target, and the control information generating unit 22b generates control information for controlling travel of the plurality of robots 110-1 and 110-2 included in the mobile interaction robot 100b on the basis of the monitoring state information acquired by the monitoring state information acquiring unit 25 and the mobile interaction robot information acquired by the information acquiring unit 21b.

With this configuration, the control device 20b can provide a wide variety of HCI.

In addition, with this configuration, the control device 20b can accurately control travel of the robots 110-1 and 110-2 included in the mobile interaction robot 100b as a control target depending on a state of a monitoring target and a state of the mobile interaction robot 100b.

In addition, with this configuration, the control device 20b can move the external device 30 by accurately moving the mobile interaction robot 100b depending on a state of a monitoring target and a state of the mobile interaction robot 100b.

Note that, in the third embodiment, the monitoring target has been described as, for example, the external device 30, but the monitoring target is not limited to the external device 30. The monitoring target may be a clock, a sensor, or the like.

In addition, in the third embodiment, the object moved by the mobile interaction robot 100b has been described as the external device 30, but the object moved by the mobile interaction robot 100b is not limited to the external device 30. The object moved by the mobile interaction robot 100b may be an object or the like other than the external device 30, disposed on a surface on which the robot 110-1 and the robot 110-2 included in the mobile interaction robot 100b travel.

In addition, in the third embodiment, the monitoring target has been described as being the same as the object moved by the mobile interaction robot 100b, but the monitoring target may be different from the object moved by the mobile interaction robot 100b.

In addition, in the third embodiment, the long object 120b has been described as a cable member, but the long object 120b is not limited to the cable member. The long object 120b may be made of, for example, a rod-shaped plastic material having a linear shape, a curved shape, or the like.

In addition, the mobile interaction robot 100b described above has been described as a mobile interaction robot including the two self-propelled robots 110-1 and 110-2, in which the two self-propelled robots 110-1 and 110-2 are connected to each other by the long object 120b. However, for example, similarly to the mobile interaction robot 100 illustrated in FIG. 8, the mobile interaction robot 100b may be a mobile interaction robot including three or more self-propelled robots, in which the three or more self-propelled robots are connected to each other by the long object 120b.

### Fourth Embodiment

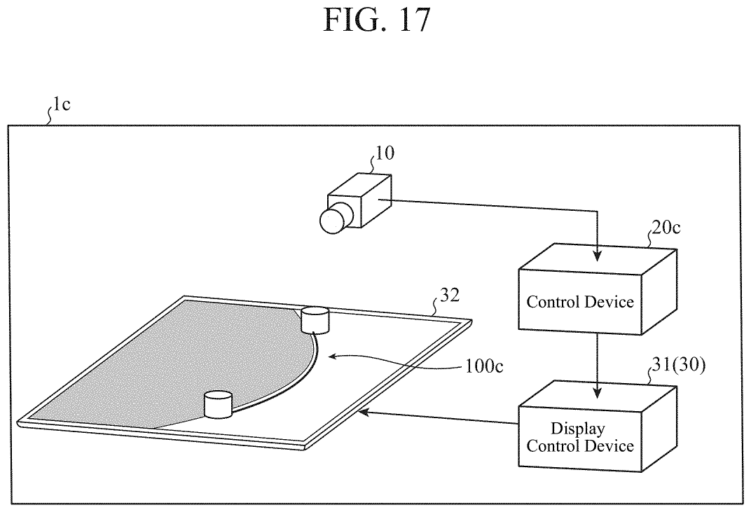

A mobile interaction robot 100c and a control device 20c according to a fourth embodiment will be described with reference to FIGS. 17 to 20.

FIG. 17 is a configuration diagram illustrating an example of a configuration of a main part of a robot system 1c to which the mobile interaction robot 100c and the control device 20c according to the fourth embodiment are applied.

The robot system 1c is obtained, in the robot system 1 according to the first embodiment, by changing the mobile interaction robot 100 and the control device 20 of the robot system 1 according to the first embodiment to the mobile interaction robot 100c and the control device 20c.

The robot system 1c includes the mobile interaction robot 100c, an imaging device 10, the control device 20c, a display control device 31 which is an external device 30, and a display device 32.

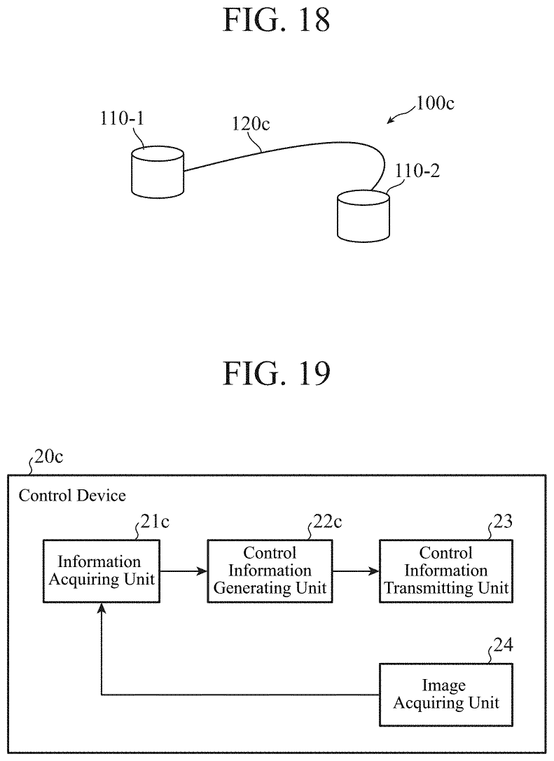

FIG. 18 is a configuration diagram illustrating an example of a configuration of a main part of the mobile interaction robot 100c according to the fourth embodiment.

The mobile interaction robot We is obtained, in the mobile interaction robot 100 according to the first embodiment illustrated in FIG. 3, by changing the long object 120, the long object state detecting unit 130, and the information generating unit 140 of the mobile interaction robot 100 illustrated in FIG. 3 to a long object 120c, a long object state detecting unit 130c (not illustrated), and an information generating unit 140c (not illustrated).

The mobile interaction robot 100c includes robots 110-1 and 110-2, the long object 120c, the long object state detecting unit 130c, the information generating unit 140c, and an information transmission controlling unit 150.

In the configuration of the robot system 1c according to the fourth embodiment, similar components to those of the robot system 1 according to the first embodiment are denoted by the same reference numerals, and redundant description will be omitted. That is, description of components of FIG. 17 denoted by the same reference numerals as those illustrated in FIG. 1 will be omitted.

In addition, in the configuration of the mobile interaction robot 100c according to the fourth embodiment, similar components to those of the mobile interaction robot 100 according to the first embodiment are denoted by the same reference numerals, and redundant description will be omitted. That is, description of components of FIG. 18 denoted by the same reference numerals as those illustrated in FIG. 2 will be omitted.

The long object 120c is a long object made of an elastic material, a plastic material, a cable member, or the like. One end of the long object 120c is connected to the robot 110-1, and the other end of the long object 120c is connected to the robot 110-2.

That is, the mobile interaction robot 100c is obtained by connecting the self-propelled robot 110-1 and the self-propelled robot 110-2 to each other by the long object 120c.

The long object 120c according to the fourth embodiment will be described below as being made of a cable member such as a string or a wire.

The long object state detecting unit 130c is a detection means such as a sensor for detecting a state of the long object 120c. Specifically, the long object state detecting unit 130c is a detection means such as an external force sensor for detecting an external force applied to the long object 120c, a shape sensor for detecting the shape of the long object 120c, or a contact sensor for detecting contact between the long object 120c and an object other than the long object 120c or the robots 110-1 and 110-2 connected to the long object 120c. The long object state detecting unit 130c transmits a detection signal indicating the detected state of the long object 120c to the information generating unit 140c.

The long object state detecting unit 130c according to the fourth embodiment will be described as a shape sensor. The shape sensor includes, for example, a plurality of piezoelectric sensors for detecting an external force applied to a plurality of parts of the long object 120c as an elastic force generated in the long object 120c. More specifically, for example, the piezoelectric sensors as the long object state detecting unit 130c are arranged at equal intervals in the long object 120c so as to be fixed to the long object 120c.

The information generating unit 140c receives a detection signal from the long object state detecting unit 130c, and generates mobile interaction robot information indicating a state of the long object 120c on the basis of the received detection signal. More specifically, for example, by receiving a detection signal indicating an external force applied to a plurality of parts of the long object 120c from the long object state detecting unit 130c, and calculating curvature of the long object 120c at each part on the basis of the detection signal, the information generating unit 140c estimates the shape of the long object 120c. The information generating unit 140c generates the estimated shape of the long object 120c as mobile interaction robot information.

The information generating unit 140c is included in the robot 110-1, the robot 110-2, or the long object 120c.

When the information generating unit 140k includes a detection means to detect the position, moving speed, moving direction, or the like of the robot 110-1, the robot 110-2, or the long object 120c, the mobile interaction robot information generated by the information generating unit 140c may include information indicating the position, moving speed, moving direction, or the like of the robot 110-1, the robot 110-2, or the long object 120c in addition to information indicating a state of the long object 120c.

The information transmission controlling unit 150 transmits the mobile interaction robot information generated by the information generating unit 140c to the control device 20c.

Note that the long object state detecting unit 130c, the information generating unit 140c, and the information transmission controlling unit 150 operate by receiving power supply from a power supply means (not illustrated) such as a battery included in the long object 120c, a power supply means (not illustrated) such as a battery included in the robot 110-1 or the robot 110-2, or the like.

In addition, the functions of the information generating unit 140c and the information transmission controlling unit 150 in the mobile interaction robot 100c are implemented by at least one of a processor and a memory, or a processing circuit. The processor and the memory or the processing circuit for implementing the functions of the information generating unit 140c and the information transmission controlling unit 150 in the mobile interaction robot 100c is included in the long object 120c, the robot 110-1, or the robot 110-2. Since the processor, the memory, and the processing circuit have been described above, description thereof will be omitted.

In addition, in the mobile interaction robot 100c, the information generating unit 140c is not an essential component, and the mobile interaction robot 100c does not have to include the information generating unit 140c. When the mobile interaction robot 100c does not include the information generating unit 140c, for example, the information transmission controlling unit 150 receives a detection signal from the long object state detecting unit 130c, and the information transmission controlling unit 150 transmits the received detection signal to the control device 20c using the detection signal as mobile interaction robot information.

The control device 20c acquires mobile interaction robot information indicating a state of the mobile interaction robot 100c, and controls a control target on the basis of the acquired mobile interaction robot information.

The control target controlled by the control device 20c is the mobile interaction robot 100c, or the mobile interaction robot 100c and the external device 30.

A configuration of a main part of the control device 20c according to the fourth embodiment will be described with reference to FIG. 19.

FIG. 19 is a block diagram illustrating an example of a configuration of a main part of the control device 20c according to the fourth embodiment.

The control device 20c is obtained, in the control device 20 according to the first embodiment, by changing the information acquiring unit 21 and the control information generating unit 22 in the control device 20 according to the first embodiment to an information acquiring unit 21c and a control information generating unit 22c.

The control device 20c includes the information acquiring unit 21c, the control information generating unit 22c, a control information transmitting unit 23, and an image acquiring unit 24.

In the configuration of the control device 20c according to the fourth embodiment, similar components to those of the control device 20 according to the first embodiment are denoted by the same reference numerals, and redundant description will be omitted. That is, description of components of FIG. 19 denoted by the same reference numerals as those illustrated in FIG. 4 will be omitted.

The information acquiring unit 21c acquires mobile interaction robot information indicating a state of the mobile interaction robot 100c.

Specifically, the information acquiring unit 21c acquires mobile interaction robot information by receiving mobile interaction robot information transmitted by the mobile interaction robot 100c.

More specifically, the information acquiring unit 21c acquires mobile interaction robot information indicating a state of the mobile interaction robot 100c, such as the position, moving speed, moving direction, or the like of the robot 110-1 included in the mobile interaction robot 100c, the position, moving speed, moving direction, or the like of the robot 110-2 included in the mobile interaction robot 100c, or the position, moving speed, moving direction, state, or the like of the long object 120c included in the mobile interaction robot 100c.

In addition, the information acquiring unit 21c may include an image analysis means, and may acquire mobile interaction robot information by analyzing image information acquired by the image acquiring unit 24 from the imaging device 10.

More specifically, by analyzing the image information acquired by the image acquiring unit 24 from the imaging device 10, the information acquiring unit 21c acquires mobile interaction robot information indicating a state of the mobile interaction robot 100c, such as the position, moving speed, moving direction, or the like of the robot 110-1 included in the mobile interaction robot 100c, the position, moving speed, moving direction, or the like of the robot 110-2 included in the mobile interaction robot 100c, or the position, moving speed, moving direction, state, or the like of the long object 120c included in the mobile interaction robot 100c. In addition, the information acquiring unit 21c may acquire mobile interaction robot information indicating the shape of the long object 120c included in the mobile interaction robot 100c by analyzing image information acquired by the image acquiring unit 24 from the imaging device 10.

When the imaging device 10 captures an image of the external device 30, a user, or the like in addition to an image of the mobile interaction robot 100c, by analyzing the image information acquired by the image acquiring unit 24 from the imaging device 10, the information acquiring unit 21c may acquire information indicating a relative position of the mobile interaction robot 100c, or the robot 110-1, the robot 110-2, or the long object 120c included in the mobile interaction robot 100c with respect to the external device 30, the user, or the like as mobile interaction robot information.

The control information generating unit 22c generates control information for controlling a control target on the basis of the mobile interaction robot information acquired by the information acquiring unit 21c.

For example, the control information generating unit 22c generates control information for controlling the mobile interaction robot 100c on the basis of the mobile interaction robot information acquired by the information acquiring unit 21c.

Specifically, the control information generating unit 22c generates control information for controlling travel of the robot 110-1 and the robot 110-2 included in the mobile interaction robot 100c on the basis of the mobile interaction robot information acquired by the information acquiring unit 21c.

More specifically, the control information generating unit 22c generates control information for controlling travel of the robot 110-1 and the robot 110-2 on the basis of the position, moving speed, moving direction, or the like of the robot 110-1, the position, moving speed, moving direction, or the like of the robot 110-2, or the position, moving speed, moving direction, state, or the like of the long object 120c, indicated by the mobile interaction robot information.

In addition, for example, the control information generating unit 22c may generate control information for controlling the external device 30 on the basis of the mobile interaction robot information in addition to the control information for controlling the mobile interaction robot 100c.

The control information transmitting unit 23 transmits the control information generated by the control information generating unit 22c to the mobile interaction robot 100c or the external device 30 as a control target.

Note that the functions of the information acquiring unit 21c, the control information generating unit 22c, the control information transmitting unit 23, and the image acquiring unit 24 in the control device 20c according to the fourth embodiment may be implemented by the processor 501 and the memory 502 in the hardware configuration exemplified in FIGS. 5A and 5B in the first embodiment, or may be implemented by the processing circuit 503.

The external device 30 according to the fourth embodiment will be described as the display control device 31 for performing output control of a display image on the display device 32 such as a tabletop type display. In addition, the robot 110-1 and the robot 110-2 included in the mobile interaction robot 100c will be described as robots traveling in a display region formed by a plane in the display device 32.

HCI according to the fourth embodiment will be described.

In fifth HCI according to the fourth embodiment, the external device 30 is controlled, for example, when a user moves the robot 110-1, the robot 110-2, or the long object 120c included in the mobile interaction robot 100c, and changes the shape of the long object 120c. The shape of the long object 120c may be changed when the mobile interaction robot 100c acquires the control information generated by the control information generating unit 22c, and the robot 110-1 or the robot 110-2 included in the mobile interaction robot 100c moves on the basis of the acquired control information. Specifically, for example, in the fifth HCI, the display control device 31 which is the external device 30 is controlled so as to correspond to the shape of the long object 120c on the basis of mobile interaction robot information indicating the shape of the long object 120c. More specifically, for example, in the fifth HCI, control is performed in such a manner that a display image output from the display control device 31 to the display device 32 is changed on the basis of the mobile interaction robot information indicating the shape of the long object 120c.

On the basis of the mobile interaction robot information indicating the shape of the long object 120c and the mobile interaction robot information indicating the position of the robot 110-1, the position of the robot 110-2, the position of the long object 120c, or the like, for example, as illustrated in FIG. 17, the control information generating unit 22c divides a display region in the display device 32 on the basis of the position of the long object 120c, and generates control information for causing the display control device 31 to perform display in such a manner that display varies depending on a divided display region.

The control information transmitting unit 23 transmits the control information generated by the control information generating unit 22c to the display control device 31 as a control target.

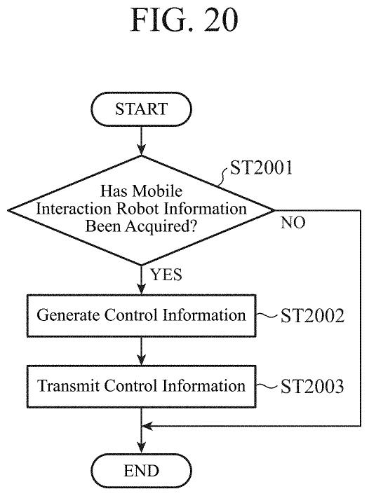

FIG. 20 is a flowchart for explaining an example of processing of the control device 20c according to the fourth embodiment. The control device 20c repeatedly executes the processing of the flowchart.

First, in step ST2001, the information acquiring unit 21c determines whether or not mobile interaction robot information indicating the shape of the long object 120c has been acquired.

In step ST2001, if the information acquiring unit 21c determines that mobile interaction robot information has not been acquired from the mobile interaction robot 100c, the control device 20c ends the processing of the flowchart, returns to step ST2001, and repeatedly executes the processing of the flowchart.

In step ST2001, if the information acquiring unit 21c determines that mobile interaction robot information has been acquired from the mobile interaction robot 100c, in step ST2002, the control information generating unit 22c generates control information for controlling the display control device 31 which is the external device 30 on the basis of the mobile interaction robot information.

After step ST2002, in step ST2003, the control information transmitting unit 23 transmits the control information generated by the control information generating unit 22c to the external device 30.

After step ST2003, the control device 20c ends the processing of the flowchart, returns to step ST2001, and repeatedly executes the processing of the flowchart.

The external device 30 acquires the control information transmitted by the control device 20c and operates on the basis of the acquired control information. Specifically, for example, the display control device 31 which is the external device 30 generates a display image on the basis of the acquired control information, and outputs the display image to the display device 32.

As described above, in the mobile interaction robot 100c, a plurality of self-propelled robots is connected to each other by the long object 120c.

With this configuration, the mobile interaction robot 100c can provide a wide variety of HCI.

In addition, in the above-described configuration, the long object 120c included in the mobile interaction robot 100c is made of a cable member.

With this configuration, the mobile interaction robot 100c can provide a wide variety of HCI.

In addition, with this configuration, the mobile interaction robot 100c can indicate a region by the long object 120c even when the number of robots is small.

In addition, the mobile interaction robot 100c includes the long object state detecting unit 130c for detecting a state of the long object 120c in addition to the above-described configuration.

With this configuration, the mobile interaction robot 100c can provide a wide variety of HCI.

In addition, in the above-described configuration, the long object state detecting unit 130c included in the mobile interaction robot 100c detects the shape of the long object 120c.

With this configuration, the mobile interaction robot 100c can provide a wide variety of HCI.

In addition, with this configuration, by detecting the shape of the long object 120c, the mobile interaction robot 100c can indicate a region by the long object 120c even when the number of robots is small.

In addition, the control device 20c includes the information acquiring unit 21c for acquiring mobile interaction robot information indicating a state of the mobile interaction robot 100c, and the control information generating unit 22c for generating control information for controlling a control target on the basis of the mobile interaction robot information acquired by the information acquiring unit 21c.

With this configuration, the control device 20c can provide a wide variety of HCI.

In addition, with this configuration, the control device 20c can cause the external device 30 as a control target to perform a desired operation depending on a state of the mobile interaction robot 100c.

In addition, in the above-described configuration, the mobile interaction robot information acquired by the information acquiring unit 21c included in the control device 20c includes information indicating the shape of the long object 120c included in the mobile interaction robot 100c.

With this configuration, the control device 20c can provide a wide variety of HCI.

In addition, with this configuration, the control device 20c can acquire a region indicated by the long object 120c on the basis of the shape of the long object 120c included in the mobile interaction robot 100c, and cause the external device 30 as a control target to perform a desired operation depending on the acquired region.

In addition, in the above-described configuration, the control information generated by the control information generating unit 22c included in the control device 20c is control information for controlling the external device 30, and the control information generating unit 22c generates the control information for controlling the external device 30 on the basis of the mobile interaction robot information acquired by the information acquiring unit 21c.

With this configuration, the control device 20c can provide a wide variety of HCI.

In addition, with this configuration, the control device 20c can cause the external device 30 as a control target to perform a desired operation depending on a state of the mobile interaction robot 100c.

In addition, in the above-described configuration, the control information generated by the control information generating unit 22c included in the control device 20c is control information for controlling the display control device 31 which is the external device 30, and the control information generating unit 22c generates control information for controlling the display control device 31 for performing output control of a display image displayed on the display device 32 constituting a plane on which the robots included in the mobile interaction robot 100c travel on the basis of the mobile interaction robot information acquired by the information acquiring unit 21c.

With this configuration, the control device 20c can provide a wide variety of HCI.

In addition, with this configuration, the control device 20c can cause the display control device 31 as a control target to control a display image on which the display control device 31 performs output control depending on a state of the mobile interaction robot 100c.

Note that in the fourth embodiment, the long object 120c has been described as a cable member, but the long object 120c is not limited to the cable member. The long object 120c may be made of, for example, an elastic material such as a spring or an elastic resin.

In addition, the mobile interaction robot 100c described above has been described as a mobile interaction robot including the two self-propelled robots 110-1 and 110-2, in which the two self-propelled robots 110-1 and 110-2 are connected to each other by the long object 120c. However, for example, similarly to the mobile interaction robot 100 illustrated in FIG. 8, the mobile interaction robot 100c may be a mobile interaction robot including three or more self-propelled robots, in which the three or more self-propelled robots are connected to each other by the long object 120c.

Note that the present invention can freely combine the embodiments to each other, modify any constituent element in each of the embodiments, or omit any constituent element in each of the embodiments within the scope of the invention.

### Industrial Applicability

The mobile interaction robot according to the present invention can be applied to a robot system.

### REFERENCE SIGNS LIST

1, 1a, 1b, 1c: Robot system, 10: Imaging device, 20, 20a, 20b, 20c: Control device, 21, 21a, 21b, 21c: Information acquiring unit, 22, 22a, 22b, 22c: Control information generating unit, 23: Control information transmitting unit, 24: Image acquiring unit, 25: Monitoring state information acquiring unit, 30: External device, 31: Display control device, 32: Display device, 100, 100a, 100b, 100c: Mobile interaction robot, 110-1, 110-2: Robot, 111: Communication unit, 112: Drive unit, 113: Drive control unit, 120, 120a, 120b, 120c: Long object, 130, 130a, 130b, 130c: Long object state detecting unit, 140, 140a, 140b, 140c: Information generating unit, 150: Information transmission controlling unit, 501: Processor, 502: Memory, 503: Processing circuit.

1. A control device comprising processing circuitry
to acquire mobile interaction robot information indicating a state of a mobile interaction robot including a plurality of self-propelled robots and a long object, the plurality of self-propelled robots being connected to each other by the long object, and
to generate control information for controlling a control target on a basis of the mobile interaction robot information.

2. The control device according to claim 1, wherein the mobile interaction robot information includes information indicating a position of the mobile interaction robot.

3. The control device according to claim 2, wherein the information indicating the position of the mobile interaction robot included in the mobile interaction robot information includes information indicating a position of each of the plurality of self-propelled robots included in the mobile interaction robot.

4. The control device according to claim 2, wherein the information indicating the position of the mobile interaction robot included in the mobile interaction robot information includes information indicating a position of the long object included in the mobile interaction robot.

5. The control device according to claim 1, wherein the mobile interaction robot information includes information indicating an external force applied to the long object included in the mobile interaction robot.

6. The control device according to claim 1, wherein the mobile interaction robot information includes information indicating a shape of the long object included in the mobile interaction robot.

7. The control device according to claim 1, wherein the mobile interaction robot information includes information indicating contact between the long object included in the mobile interaction robot and an object, the object being other than the long object or the plurality of self-propelled robots included in the mobile interaction robot.

8. The control device according to claim 1, wherein the control information is information for controlling the mobile interaction robot as the control target, and
the processing circuitry generates the control information for controlling travel of the plurality of self-propelled robots included in the mobile interaction robot on a basis of the mobile interaction robot information.

9. The control device according to claim 1, wherein the processing circuitry acquires monitoring state information indicating a state of a monitoring target, wherein
the control information is information for controlling the mobile interaction robot as the control target, and
the processing circuitry generates the control information for controlling travel of the plurality of self-propelled robots included in the mobile interaction robot on a basis of the monitoring state information and the mobile interaction robot information.

10. The control device according to claim 1, wherein the control information is information for controlling an external device, and
the processing circuitry generates the control information for controlling the external device on a basis of the mobile interaction robot information.

11. The control device according to claim 10, wherein the control information is information for controlling a display control device which is the external device, and
the processing circuitry generates the control information for controlling the display control device for performing output control of a display image displayed on a display device representing a plane on which the plurality of self-propelled robots included in the mobile interaction robot travels on a basis of the mobile interaction robot information.

12. The mobile interaction robot according to claim 1, wherein the long object is made of an elastic material.

13. The mobile interaction robot according to claim 1, wherein the long object is made of a plastic material.

14. The mobile interaction robot according to claim 1, wherein the long object is made of a cable member.

15. The mobile interaction robot according to claim 1, wherein the mobile interaction robot comprises a long object state detector to detect a state of the long object.

16. The mobile interaction robot according to claim 15, wherein the long object state detector detects an external force applied to the long object.

17. The mobile interaction robot according to claim 15, wherein the long object state detector detects a shape of the long object.

18. The mobile interaction robot according to claim 15, wherein the long object state detector detects contact between an object, the object being other than the long object or the plurality of self-propelled robots connected to the long object, and the long object.

19. A control method comprising:
acquiring mobile interaction robot information indicating a state of the mobile interaction robot including a plurality of self-propelled robots and a long object, the plurality of self-propelled robots being connected to each other by the long object; and
generating control information for controlling a control target on a basis of the mobile interaction robot information.

20. A non-transitory computer-readable medium storing a control program including instructions that, when executed by a processor, causes a computer
to acquire mobile interaction robot information indicating a state of the mobile interaction robot including a plurality of self-propelled robots and a long object, the plurality of self-propelled robots being connected to each other by the long object, and
to generate control information for controlling a control target on a basis of the mobile interaction robot information.
